(19) United States
(12) Patent Application Publication
(10) Pub. No.: US 2015/0287331 A1
(43) Pub. Date: Oct. 8, 2015

(54) Methods and Systems for Providing Quick Capture for Learning and Assessment

(71) Applicant: Freshgrade Education, Inc., Kelowna (CA)

(72) Inventors: Nathan Karsgaard, Kelowna (CA); Mark Payne, Kelowna (CA); Cayley Humphries, Kelowna (CA); Steve Wandler, Kelowna (CA); Lane Merrifield, Kelowna (CA)

(21) Appl. No.: 14/680,828

(22) Filed: Apr. 7, 2015

Related U.S. Application Data
(60) Provisional application No. 61/976,982, filed on Apr. 8, 2014.

(51) Int. Cl. G09B 7/00; H04L 29/08

(52) U.S. Cl. CPC G09B 7/00; H04L 67/32

(57) ABSTRACT

Methods and systems for providing quick capture for learning and assessment are provided herein. An example method includes providing a plurality of graphical user interfaces (GUIs), the plurality of graphical user interfaces for capturing unique categories of evidence of student learning, the evidence of student learning including a plurality of media types, receiving evidence of student learning including both media and narrative content from a teacher using the plurality of graphical user interfaces, synchronizing the evidence of student learning with one or more student accounts, and assigning at least a portion of the evidence of student learning to a student portfolio.

### CROSS REFERENCE TO RELATED APPLICATIONS

This application claims the priority benefit of U.S. Provisional Application Ser. No. 61/976,982, filed on Apr. 8, 2014, which is hereby incorporated by reference herein in its entirety—including all references and appendices cited therein.

### FIELD OF THE PRESENT TECHNOLOGY

The present technology relates generally to capturing, assessing and communicating evidence of learning. More particularly, but not by way of limitation, embodiments of the disclosure relate to systems and methods of capturing, assessing and communicating evidence of student learning in the classroom.

### BACKGROUND

Traditional educational assessment is completed by uniform methods. For example, performance of students is determined by a uniform written examination at the end of the semester. This traditional educational assessment fails to recognize that all students do not learn the same way. Rather, students learn and show evidence of learning in many different ways. Traditional educational assessment fails to capture evidence of learning in alternative manifestations. Thus, evidence of student learning is lost.

Loss of evidence of student learning prevents student learning from being assessed and communicated. The lack of assessment of student learning prevents teachers from using it to create individualized learning experiences for students. Moreover, the failure to capture evidence of student learning prevents teachers from communicating it to parents or other interested parties to update them on student progress. Thus, failure to capture, assess, and communicate evidence of student learning results in the inability of teachers to provide students with individualized learning experiences.

### SUMMARY OF THE PRESENT TECHNOLOGY

According to some embodiments, the present technology may be directed to a method that comprises capturing, assessing and communicating evidence of student learning.

According to other embodiments, the present technology may be directed to non-transitory computer readable storage mediums having a computer program embodied thereon. The computer program executable by a processor in a computing system to perform a method that includes the steps of capturing, assessing and communicating evidence of student learning.

According to various embodiments, the present technology may be directed to a system that comprises one or more client devices connected by a network to one or more servers, the devices and servers configured to capture, assess and communicate evidence of student learning.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a machine-implemented method, including: capturing, by a server, evidence of student learning; assessing, by a server, the evidence of student learning; and communicating, by a server, the evidence of student learning. The machine-implemented method also includes in which the capturing, the communicating, and the assessing make it possible for teachers to provide an individualized learning experience for students. Other embodiments of this aspect include corresponding computer systems, apparatus, and computer programs recorded on one or more computer storage devices, each configured to perform the actions of the methods.

One general aspect includes a non-transitory medium, readable through one or more processors and including instructions embodied therein that are executable through the one or more processors, including: instructions to capture, at an interface of a data processing device, evidence of student learning; instructions to assess, at an interface of a data processing device, the evidence of student learning; and instructions to communicate, at an interface of a data processing device, the evidence of student learning. The non-transitory medium also includes in which the instructions to capture, communicate, and assess make it possible for teachers to provide an individualized learning experience for students. Other embodiments of this aspect include corresponding computer systems, apparatus, and computer programs recorded on one or more computer storage devices, each configured to perform the actions of the methods.

One general aspect includes a client device and server system including: a memory; one or more processors communicatively coupled to the memory; one or more programs, stored in the memory and executed by the one or more processors; a module coupled to at least one of the one or more processors and instructed by at least one of the one or more programs to capture evidence of student learning; a module coupled to at least one of the one or more processors and instructed by at least one of the one or more programs to assess the evidence of student learning; and a module coupled to at least one of the one or more processors and instructed by at least one of the one or more programs to communicate the evidence of student learning. Other embodiments of this aspect include corresponding computer systems, apparatus, and computer programs recorded on one or more computer storage devices, each configured to perform the actions of the methods.

One general aspect includes a method, including: providing a plurality of graphical user interfaces (GUIs), the plurality of graphical user interfaces for capturing unique categories of evidence of student learning, the evidence of student learning including a plurality of media types. The method also includes receiving evidence of student learning including both media and narrative content from a teacher using the plurality of graphical user interfaces. The method also includes synchronizing the evidence of student learning with one or more student accounts. The method also includes assigning at least a portion of the evidence of student learning to a student portfolio. Other embodiments of this aspect include corresponding computer systems, apparatus, and computer programs recorded on one or more computer storage devices, each configured to perform the actions of the methods.

One general aspect includes a method, including: providing a plurality of graphical user interfaces (GUIs), the plurality of graphical user interfaces for capturing unique categories of evidence of student learning, the evidence of student learning including a plurality of media types. The method also includes receiving evidence of student learning including both media and narrative content from a teacher using the plurality of graphical user interfaces. The method also includes synchronizing the evidence of student learning with one or more student accounts. The method also includes assigning at least a portion of the evidence of student learning to a student portfolio. The method also includes generating a student snapshot that includes the evidence of student learning for one or more subjects in the student portfolio, the evidence of student learning being gathered for a time period. Other embodiments of this aspect include corresponding computer systems, apparatus, and computer programs recorded on one or more computer storage devices, each configured to perform the actions of the methods.

One general aspect includes a system, including: a device, including a processor; a memory for storing executable instructions, where the processor executes the instructions to cause a camera of the device to capture image or video evidence of student learning. The device can cause a microphone of the device to capture audio evidence of student learning. The device can cause a display of the device to present a graphical user interface that receives written evidence of student learning from a teacher. The device can transmit the image or video evidence of student learning, audio evidence of student learning, and written evidence of student learning from a teacher to an assessment server. The assessment server includes an interface that receives the image or video evidence of student learning, audio evidence of student learning, and written evidence of student learning from the teacher. The assessment server includes a processor and a memory for storing executable instructions, where the processor executes the instructions to synchronize the evidence of student learning with one or more student accounts. The processor also executes the instructions to assign at least a portion of the evidence of student learning to a student portfolio to create an individual learning experience. Other embodiments of this aspect include corresponding computer systems, apparatus, and computer programs recorded on one or more computer storage devices, each configured to perform the actions of the methods.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is an exemplary system architecture that may be utilized to practice various embodiments of the present technology.

FIG. 2 is a block diagram of an exemplary computing system for implementing some embodiments of the present technology.

FIG. 3A is a screen shot of one embodiment of a graphical user interface of the take video aspect for the quick capture feature of the present technology.

FIG. 3B is a screen shot of one embodiment of a graphical user interface of the take photo aspect for the quick capture feature of the present technology.

FIG. 4 is a screen shot of one embodiment of a graphical user interface of the share highlight aspect for the quick capture feature of the present technology in which options to save or save and share a student highlight are displayed.

FIG. 5 is a screen shot of one embodiment of a graphical user interface of the settings aspect for the quick capture feature of the present technology.

FIG. 6 is a screen shot of one embodiment of a graphical user interface of the save video aspect for the quick capture feature of the present technology.

FIG. 7 is a screen shot of one embodiment of a graphical user interface of the save note aspect for the quick note feature of the present technology.

FIG. 8 is a screen shot of one embodiment of a graphical user interface of the record audio aspect for the quick capture feature of the present technology.

FIG. 9A is a screen shot of one embodiment of a graphical user interface of the record audio aspect for the quick capture feature of the present technology in which ten seconds of recording are shown.

FIG. 9B is a screen shot of another embodiment of a graphical user interface of the record audio aspect for the quick capture feature of the present technology in which three minutes and six seconds of recording are shown.

FIG. 10 is a screen shot of one embodiment of a graphical user interface of the quick note aspect for the quick note feature of the present technology.

FIG. 11 is a screen shot of one embodiment of a graphical user interface of the preview video aspect for the quick capture feature of the present technology.

FIG. 12 is a screen shot of one embodiment of a graphical user interface of the preview audio aspect for the quick capture feature of the present technology.

FIG. 13 is a screen shot of one embodiment of a graphical user interface of the select students aspect for the quick capture feature of the present technology.

FIG. 14 is a screen shot of one embodiment of a graphical user interface of the photo note aspect for the quick note feature of the present technology.

FIG. 15 is a screen shot of one embodiment of a graphical user interface of the saving and sharing photo note aspect of the quick note feature of the present technology in which the share a student highlight option is displayed.

FIG. 16 is a screen shot of one embodiment of a graphical user interface of the saving and sharing photo note aspect of the present technology in which a note is saved and a shared message is shown.

FIG. 17 is a screen shot of one embodiment of a graphical user interface of the menu aspect for the quick capture feature of the present technology in which the photo, video, note and audio menu options are displayed.

FIG. 18 is a screen shot of one embodiment of a graphical user interface of the note saved menu aspect for the quick capture feature of the present technology in which a note saved message is shown.

FIG. 19 is a screen shot of one embodiment of a graphical user interface of the login aspect for the quick capture feature of the present technology in which login credential fields are displayed.

FIG. 20 is a screen shot of one embodiment of a graphical user interface of the confirm video aspect for the quick capture feature of the present technology.

FIG. 21 is a screen shot of one embodiment of a graphical user interface of the confirm photo aspect for the quick capture feature of the present technology.

FIG. 22 is a screen shot of one embodiment of a graphical user interface of the confirm audio aspect for the quick capture feature of the present technology.

FIG. 23 is a screen shot of one embodiment of a graphical user interface of the choose video aspect for the quick capture feature of the present technology.

FIG. 24 is a screen shot of one embodiment of a graphical user interface of the choose photo aspect for the quick capture feature of the present technology.

FIG. 25 is a screen shot of one embodiment of a graphical user interface of the audio note aspect for the quick capture feature of the present technology.

FIG. 26 is a screen shot of one embodiment of a graphical user interface of the application icon aspect of the present technology.

FIG. 27 is a screen shot of one embodiment of a graphical user interface of the teacher snapshot aspect of the present technology in which the learning snapshot and read more and comment options are shown.

FIG. 28 is a screen shot of another embodiment of a graphical user interface of the teacher snapshot aspect of the present technology in which the learning snapshot and teacher feedback for a selected student subject are displayed.

FIG. 29 is a screen shot of one embodiment of a graphical user interface of the teacher comment aspect of the present technology in which the assessment of performance of a student for a subject is shown.

FIG. 30 is a screen shot of another embodiment of a graphical user interface of the teacher comment aspect of the present technology in which teacher, student and parent comments on a student subject are displayed.

FIG. 31 is a screen shot of one embodiment of a graphical user interface of the teacher comment aspect of the present technology in which the assess activity option is shown.

FIG. 32 is a screen shot of one embodiment of a graphical user interface of the teacher assess aspect of the present technology in which the assessment of a student for a subject is on display.

FIG. 33 is a screen shot of one embodiment of a graphical user interface of the teacher activity list aspect of the present technology in which a list of unassessed student activities, quizzes, assignments and projects is displayed.

FIG. 34 is a screen shot of one embodiment of a graphical user interface of the student portfolio mobile device snapshot aspect of the present technology in which a learning snapshot with teacher, student and parent comments is on display.

FIG. 35 is a screen shot of one embodiment of a graphical user interface of the student portfolio mobile device aspect of the present technology in which assessment of activities of a student is displayed.

FIG. 36 is a screen shot of one embodiment of a graphical user interface of the student portfolio comment aspect of the present technology in which leave a comment with upload and save options are shown.

FIG. 37 is a screen shot of one embodiment of a graphical user interface of the student portfolio comment with attachments aspect of the present technology in which leave comment including attachments with upload and save options are laid out.

FIG. 38 is a screen shot of one embodiment of a graphical user interface of the student mobile scan code aspect of the present technology in which an exemplary scan code is visible.

FIG. 39 is a screen shot of another embodiment of a graphical user interface of the student mobile scan code aspect of the present technology in which an exemplary scan code that has been entered is on display.

FIG. 40 is a screen shot of one embodiment of a graphical user interface of the student mobile new entry aspect of the present technology in which message, photo, video, and audio entry options are displayed.

FIG. 41 is a screen shot of one embodiment of a graphical user interface of the student mobile login aspect of the present technology in which enter code and scan code requirements for student login are shown.

FIG. 42 is a screen shot of one embodiment of a graphical user interface of the student mobile disconnect aspect of the present technology in which student logout is on display.

FIG. 43 is a screen shot of one embodiment of a graphical user interface of the parent portfolio snapshot aspect of the present technology in which the learning snapshot with teacher, student and parent comments are laid out.

FIG. 44 is a screen shot of one embodiment of a graphical user interface of the parent portfolio snapshot aspect of the present technology in which assessments of student activities are displayed.

FIG. 45 is a screen shot of one embodiment of a graphical user interface of the parent portfolio menu aspect of the present technology in which portfolio, learning snapshots, email teacher and log out menu options are displayed.

FIG. 46 is a screen shot of one embodiment of a graphical user interface of the parent portfolio light box aspect of the present technology in which a light box image is shown.

FIG. 47 is a flowchart of an example method of the present technology.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the present technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

The present technology makes it possible to capture evidence of learning, assess it, and communicate it easily. This ability to quickly capture evidence of learning anytime, and anywhere, saves users time. The present technology makes it possible for teachers to provide an individualized learning experience for their students by reducing the time spent planning lessons, searching for resources, and recording specific student data.

These and other advantages of the present technology are provided in greater detail with reference to the drawings.

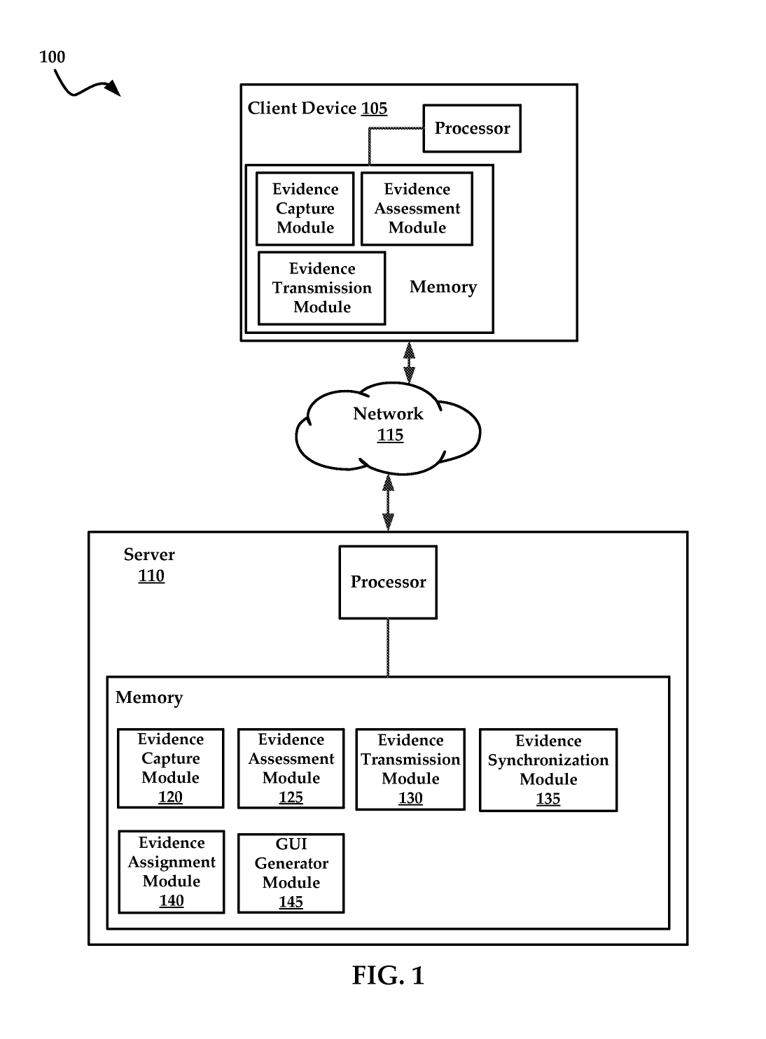

FIG. 1 is a block diagram of an exemplary architecture 100 in which embodiments of the present technology may be practiced. According to some embodiments, the architecture 100 may comprise a client device 105, which in some instances may comprise an end user computing device, a mobile computing device, or any other device capable of displaying graphical user interfaces (“GUIs”) and allowing an end user to interact with such GUIs.

The client device 105 may be communicatively coupled with a server 110 via a network 115, which may comprise a local area network (“LAN”), a wide area network (“WAN”), or any other private or public network, such as the Internet. The network 115 may also comprise a telecommunications network.

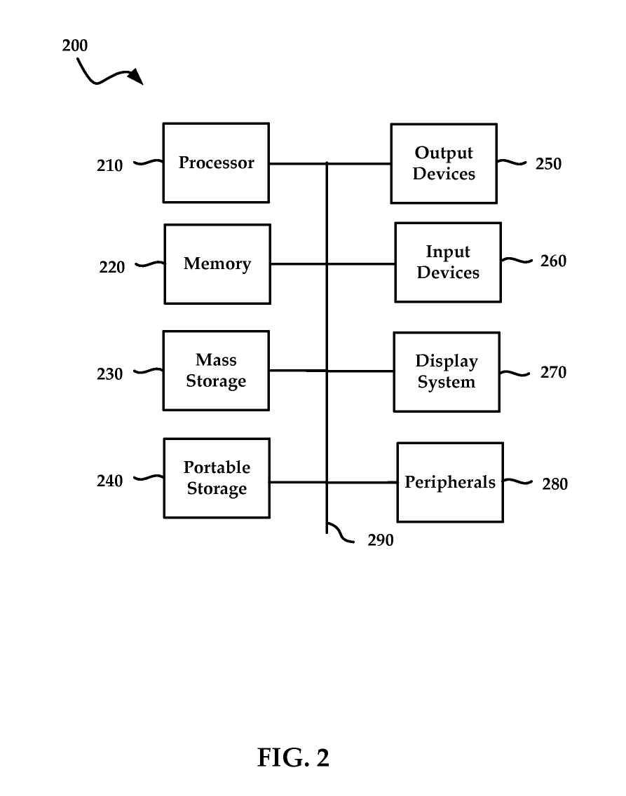

According to some embodiments, the server 110 may comprise any computing device, such as the computing device 200 of FIG. 2. The server 110 includes one or more processors such as the one or more processors 210 of FIG. 2, and memory for storing executable instructions (e.g., logic) such as the main memory 220 of computing device 200. This logic, when executed by the one or more processors, is operable to perform operations, including the exemplary methods described herein.

In some instances, the functions of the server 110 may be implemented within a cloud-based computing environment. In general, a cloud-based computing environment is a resource that typically combines the computational power of a large model of processors and/or that combines the storage capacity of a large model of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of servers, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

The server 110 can, in some embodiments, comprise an evidence capture module 120, an evidence assessment module 125, an evidence transmission module 130, an evidence synchronization module 135, an evidence assignment module 140, and a GUI generator module 145. The server 110 can include additional or fewer modules that those illustrated in FIG. 1. The respective functions executed by a module can depend on the device executing the module. For example, the evidence capturing module 120 can be used to capture evidence of learning through the capturing of images, video, audio, and so forth when the client device 105 is executing the evidence capturing module. When the server 110 executes the evidence capturing module 120, the evidence capturing module 120 can be configured to receive captured evidence of learning from the client device 105. The server 110 may not directly capture the evidence of learning, but may capture, receive, or obtain the evidence of learning indirectly from the client device.

To be sure, in some embodiments, the server 110 can execute one or more of the modules set forth above. In other embodiments, the server 110 can cooperatively execute a portion of the modules, while the client device 105 executes other portions of the modules. By way of example the client device 105 can execute an evidence capturing module and an evidence transmission module. The server 110 can execute the evidence assessment, synchronization, assignment, and GUI generator modules. In other embodiments, all of the modules can be executed by the client device alone.

A module (or application), as referenced in the present disclosure, should be generally understood as a collection of routines that perform various system-level functions and may be dynamically loaded and unloaded by hardware and device drivers as required. The modular software components described herein may also be incorporated as part of a larger software platform or integrated as part of an application specific component. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

According to some embodiments, the server 110 may execute logic stored in memory to facilitate a method for capturing, assessing and communicating evidence of student learning with various embodiments of software interfaces disclosed herein.

The server 110 may allow for documenting evidence of learning with photos, videos and audio recordings as well as adding anecdotal notes of photos, videos and audio recordings. When connected to the network, the server 110 may also permit syncing of photos, videos, audio recordings, and other evidence of learning to one account. The server 110 may further allow for assigning the evidence of learning to one or more student portfolios, automatically uploading inputs to student portfolios, assigning evidence of learning across multiple subjects, and/or classes, and/or activities for a student, and adding and editing quick notes for repetitive anecdotal notes.

Stated concisely, one example technical effect described herein is the ability of the server 110 or other computing device to capture evidence of student learning through communication with a client device. The system allows the user to capture evidence of learning with various media forms so that this evidence of learning can be assessed and communicated.

Generally, the server 110 may execute logic via the one or more processors to document evidence of student learning. The system allows the user to capture evidence of learning with various media forms so that this evidence of learning can be assessed and communicated effectively and efficiently.

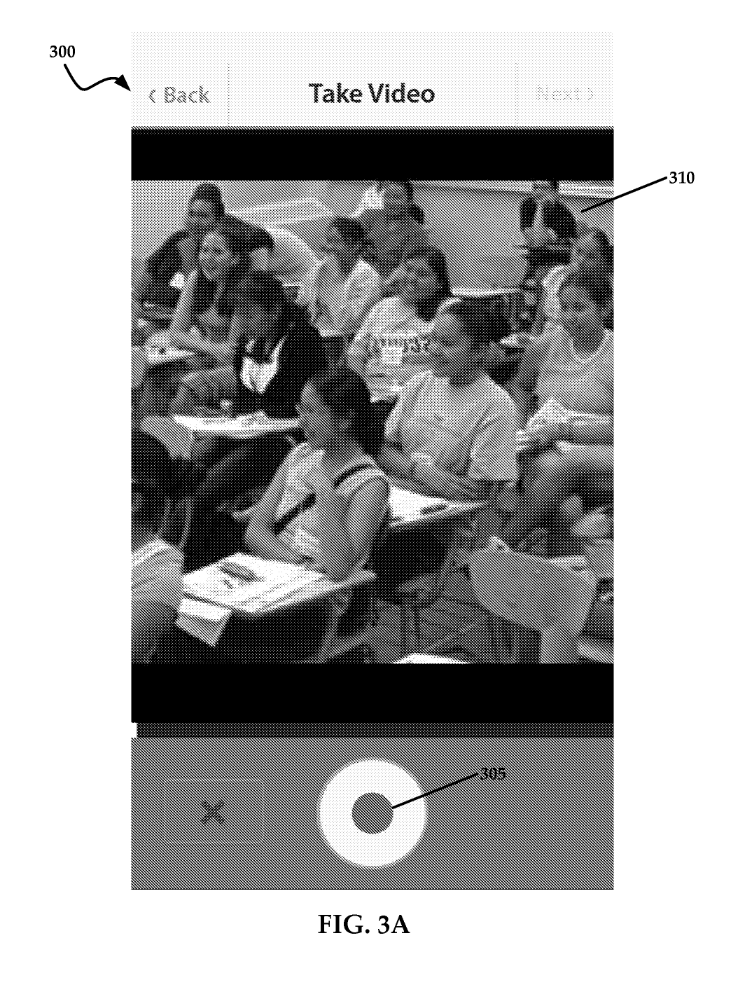

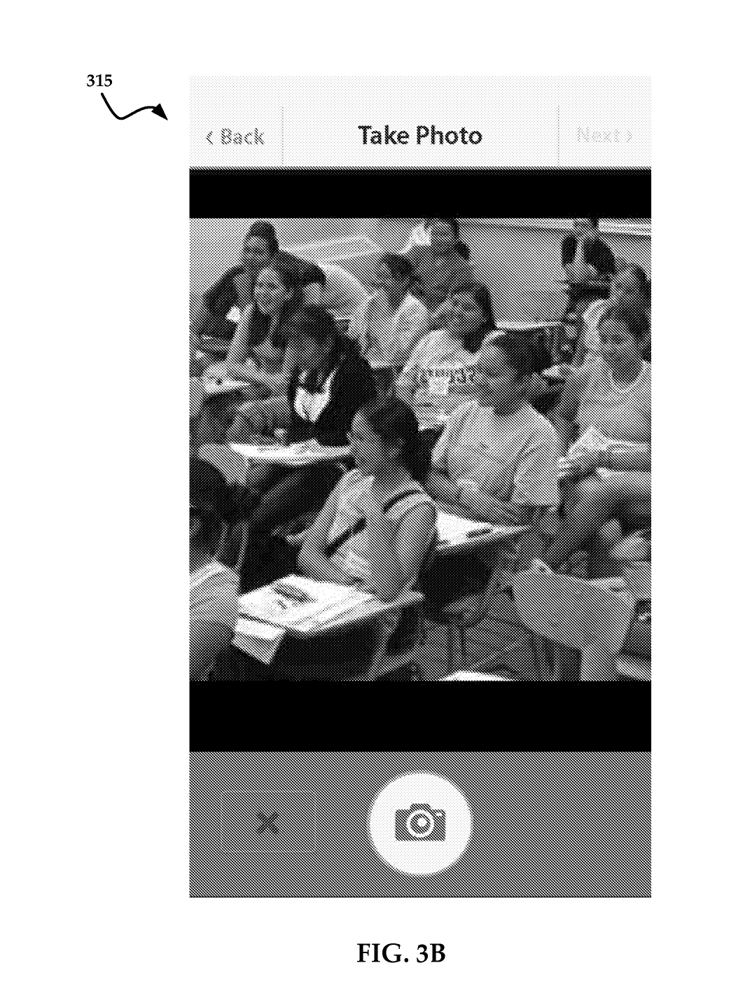

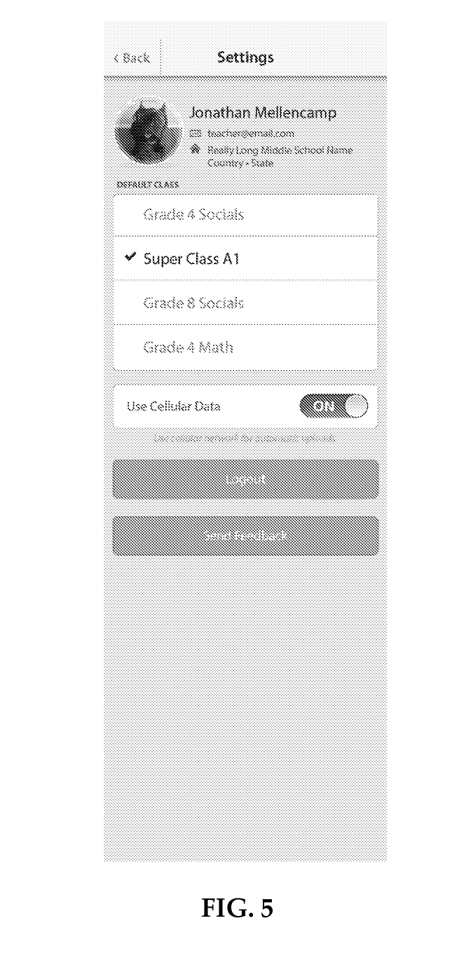

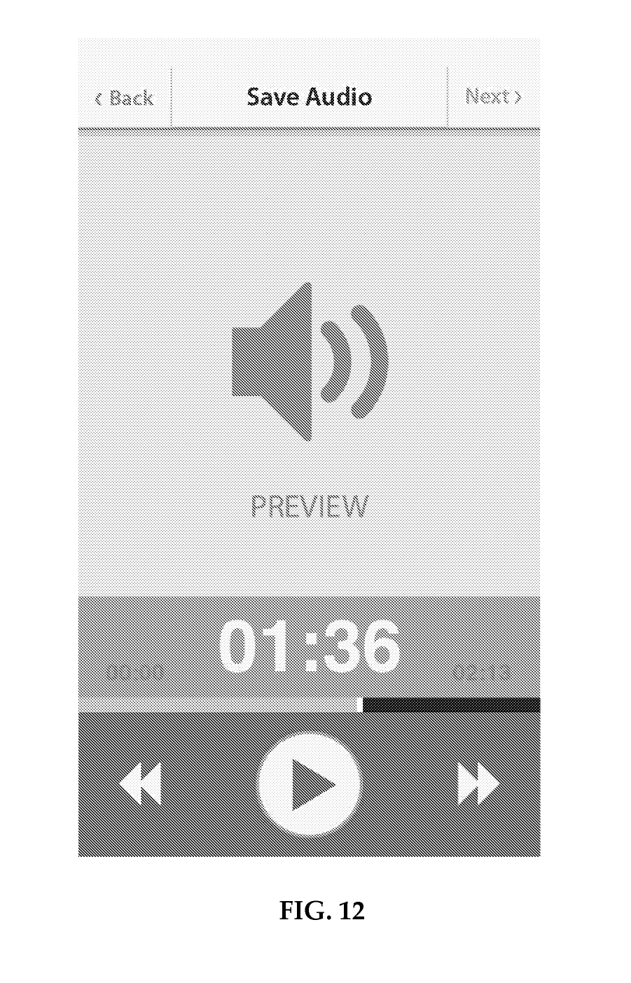

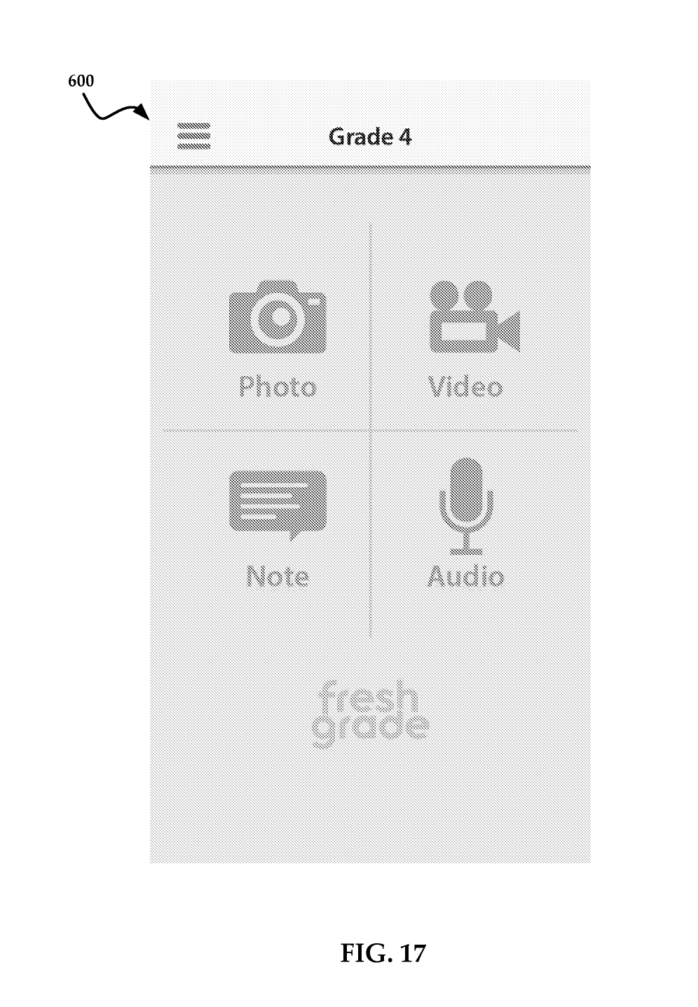

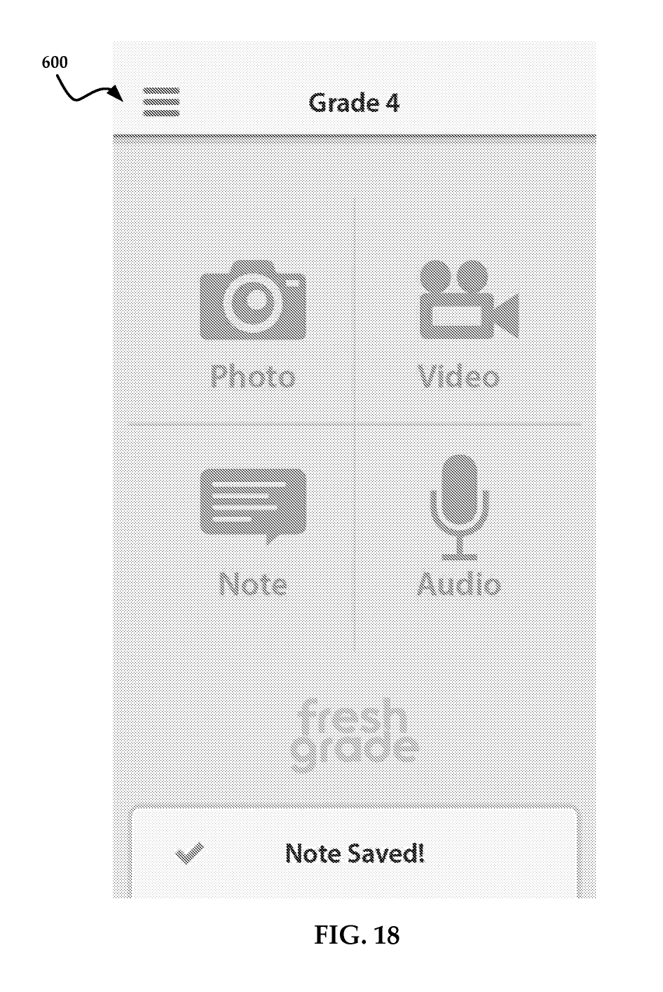

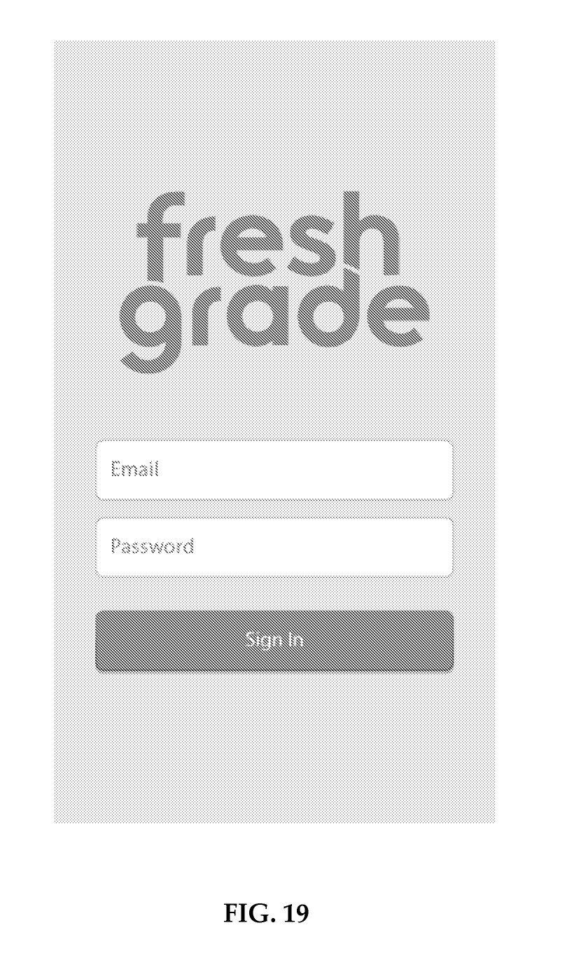

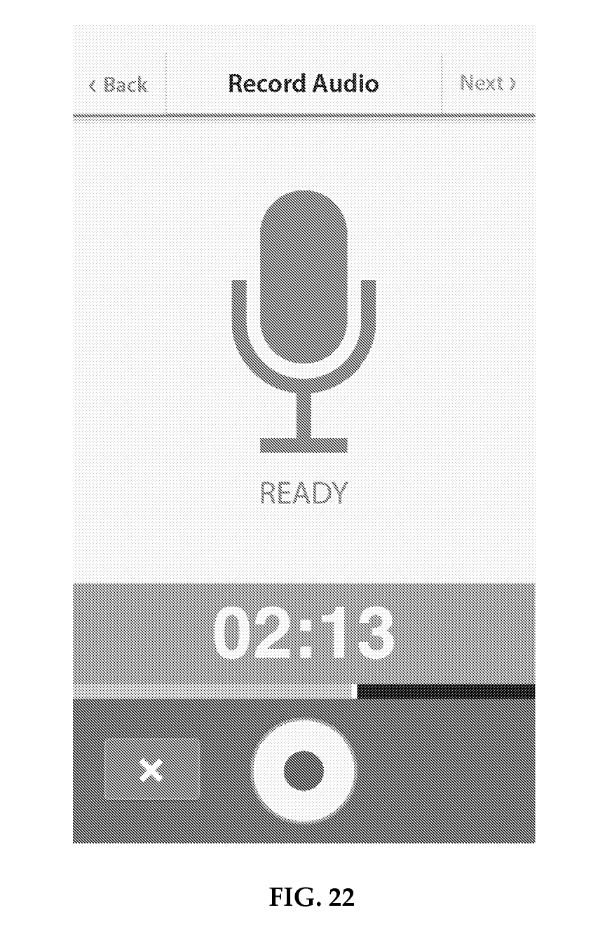

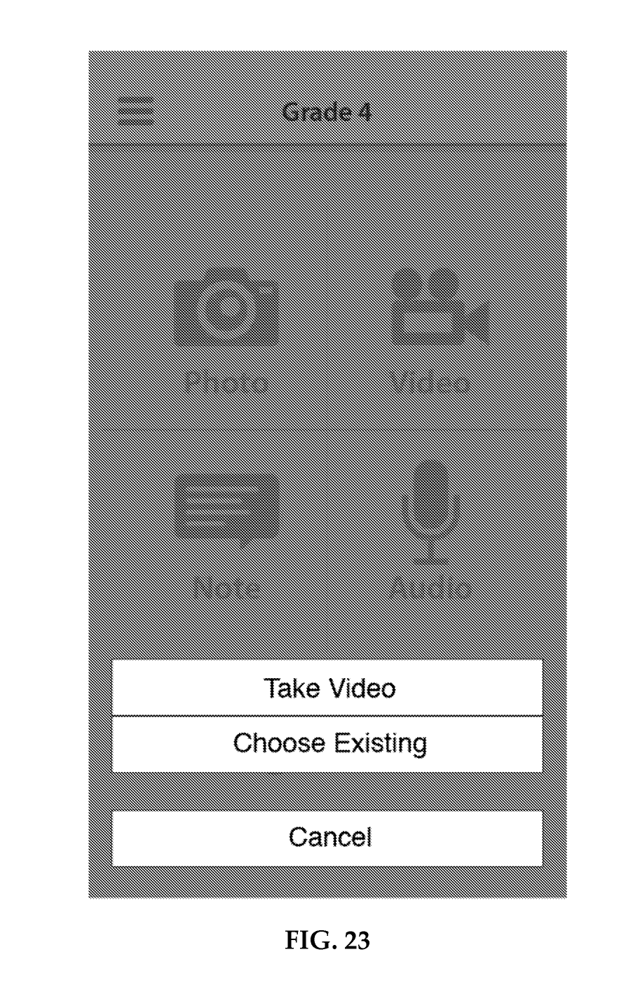

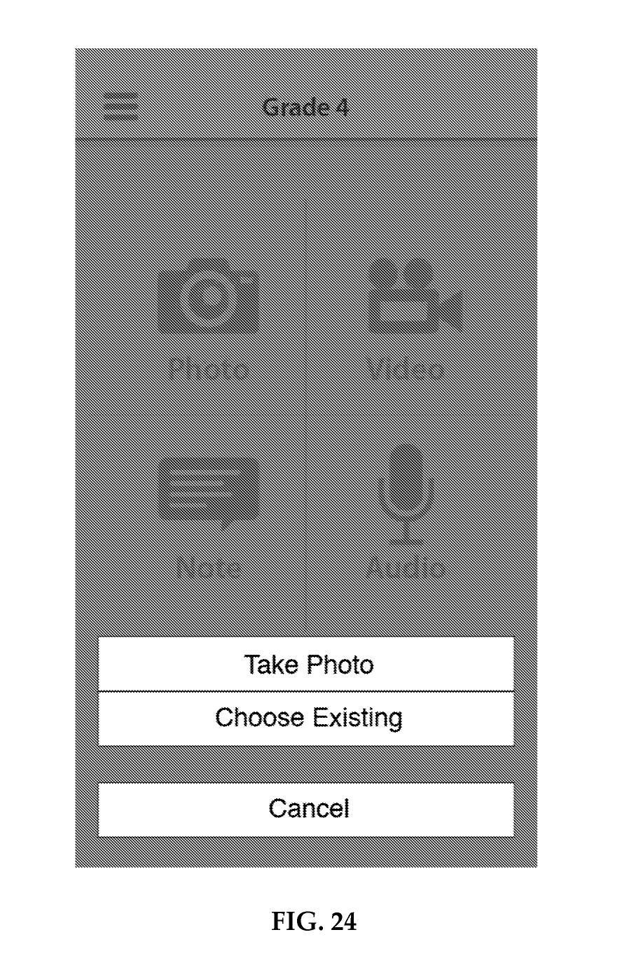

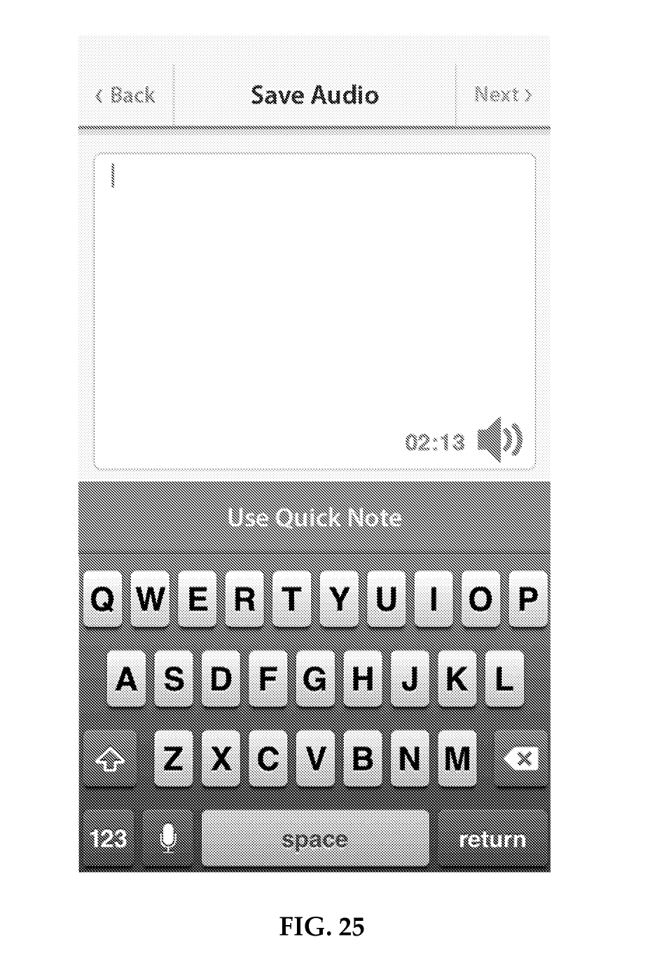

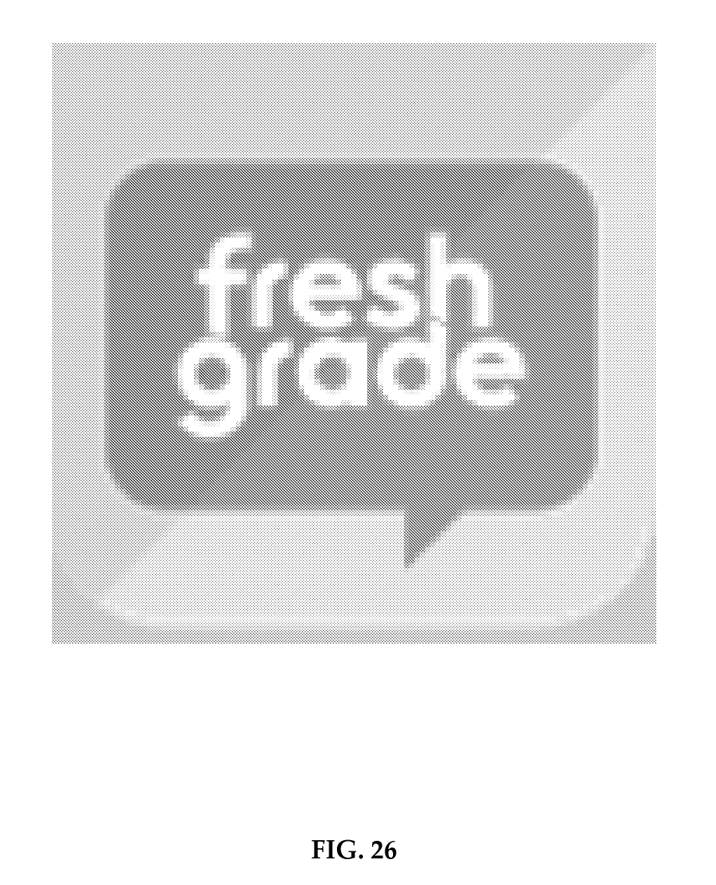

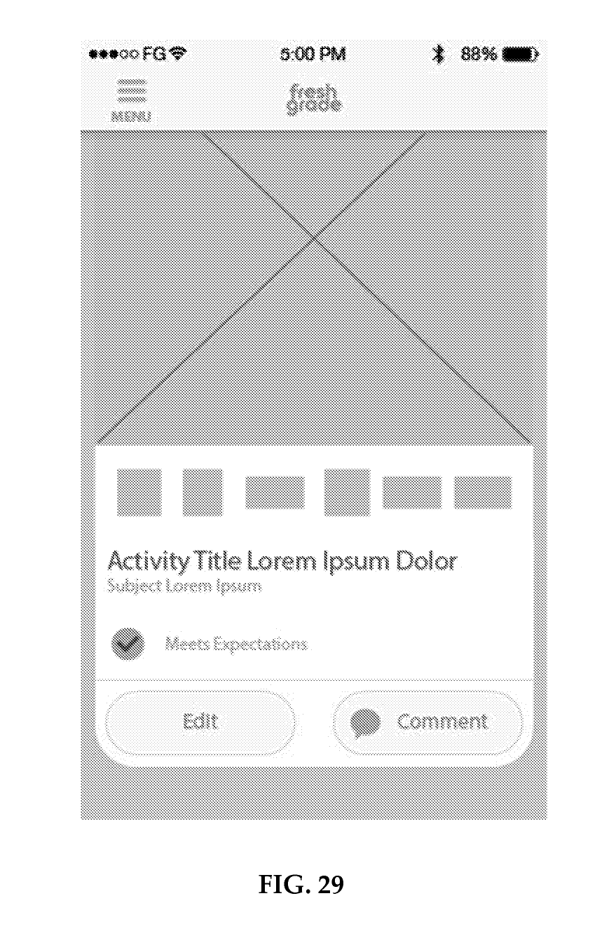

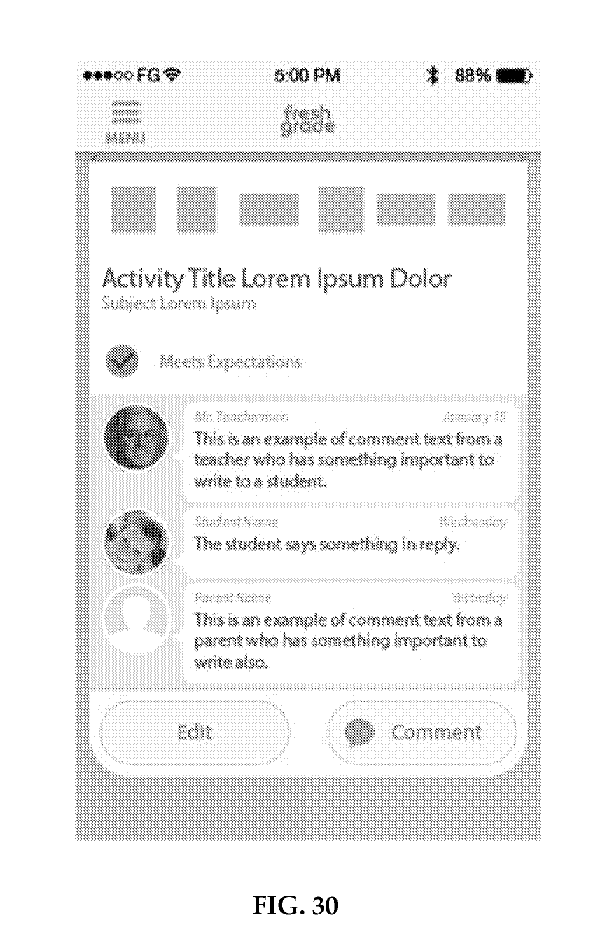

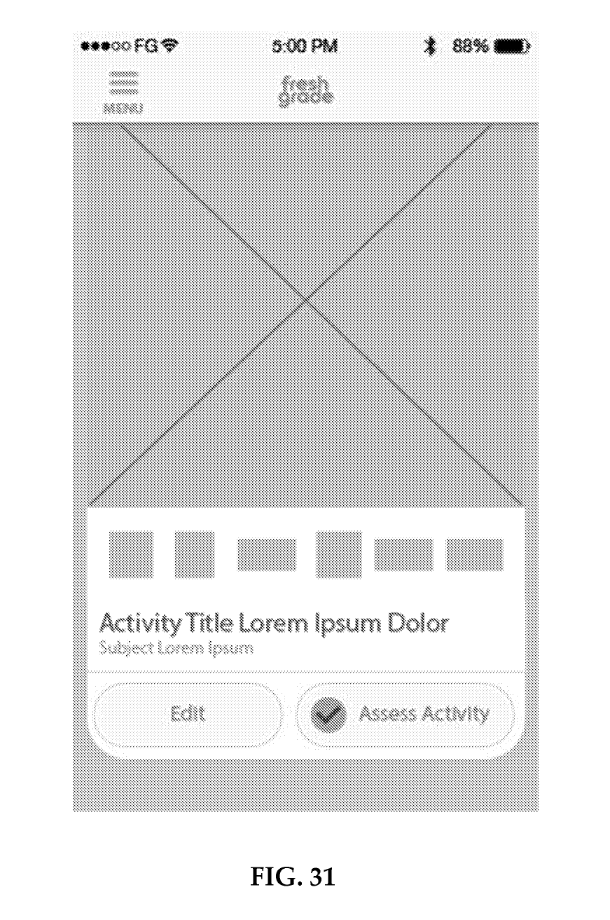

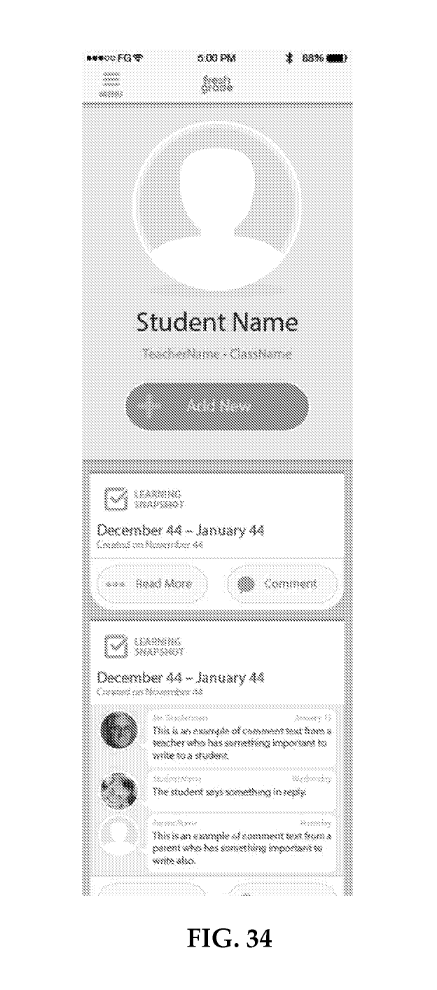

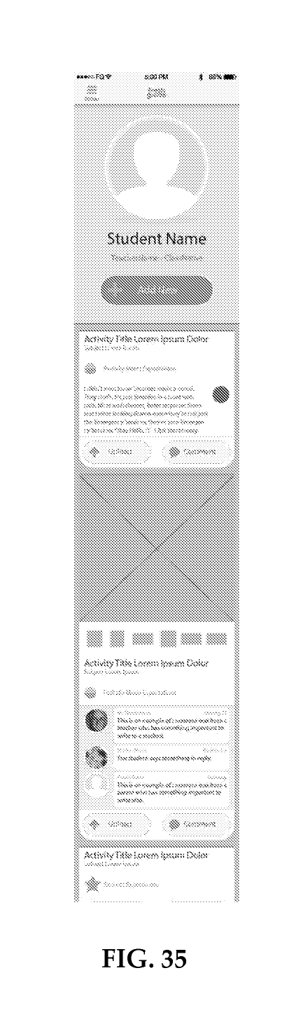

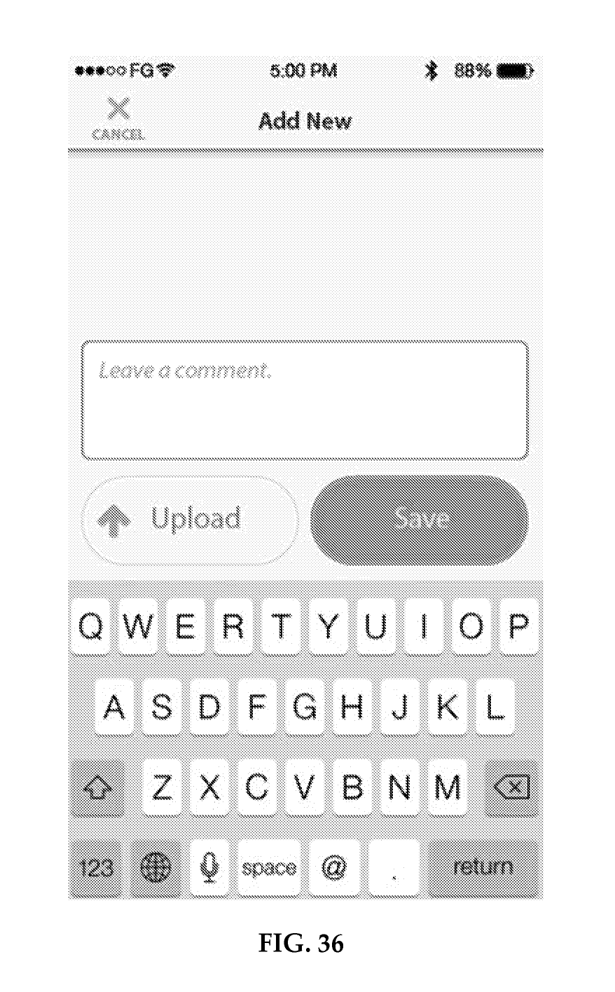

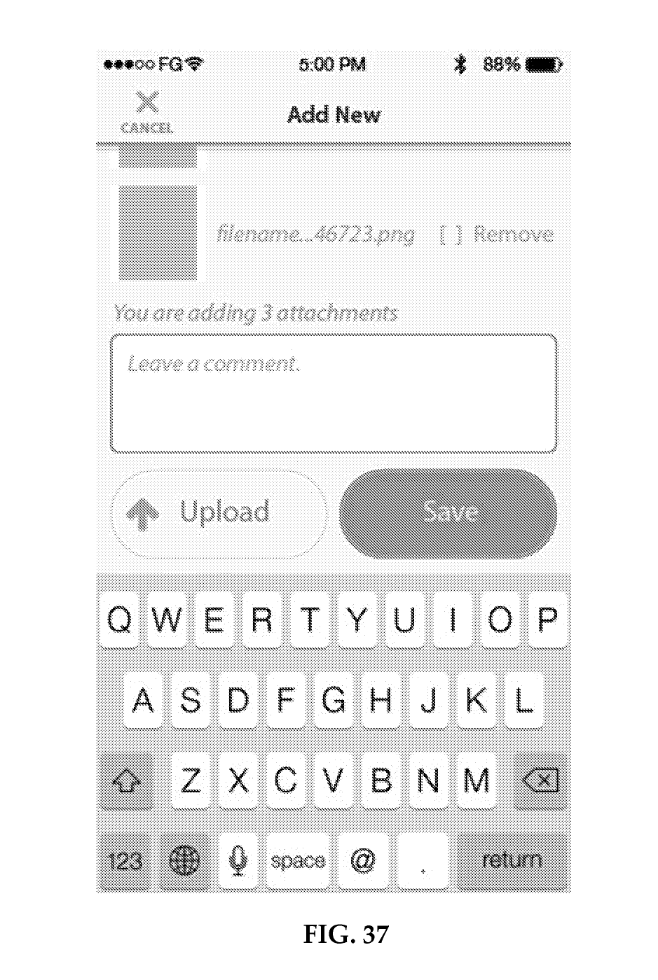

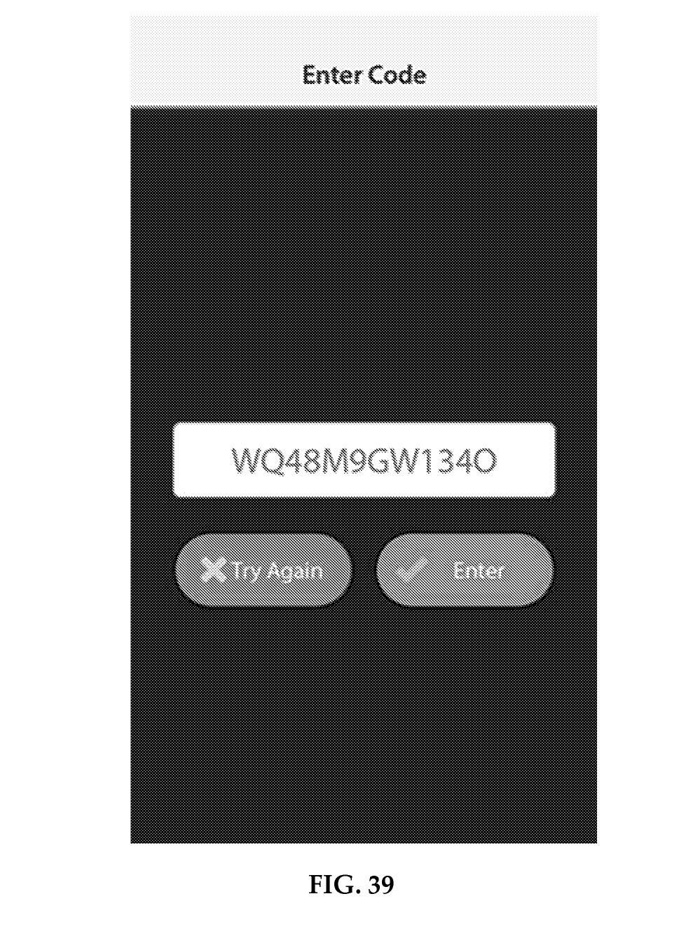

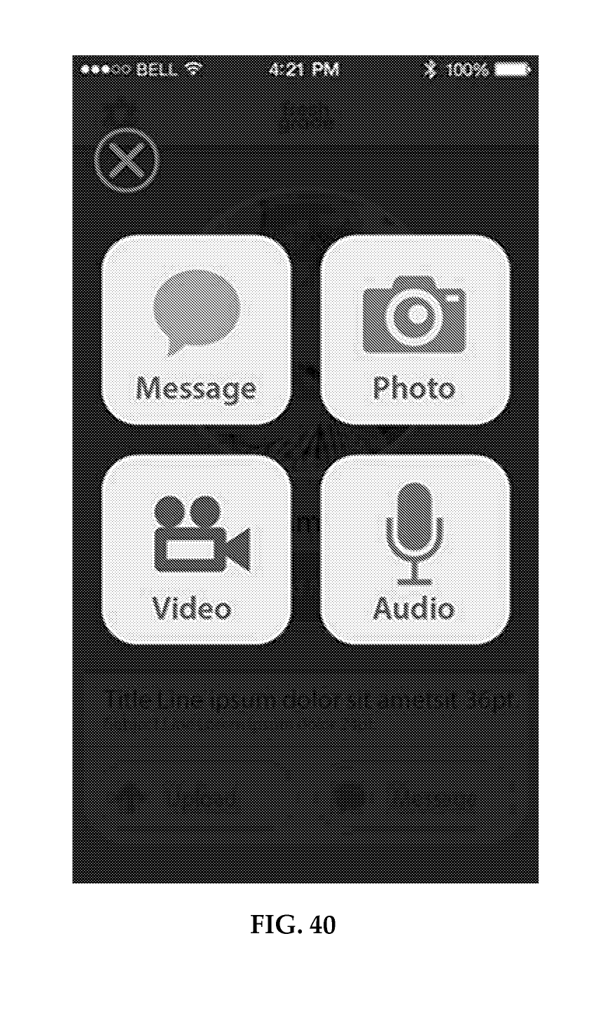

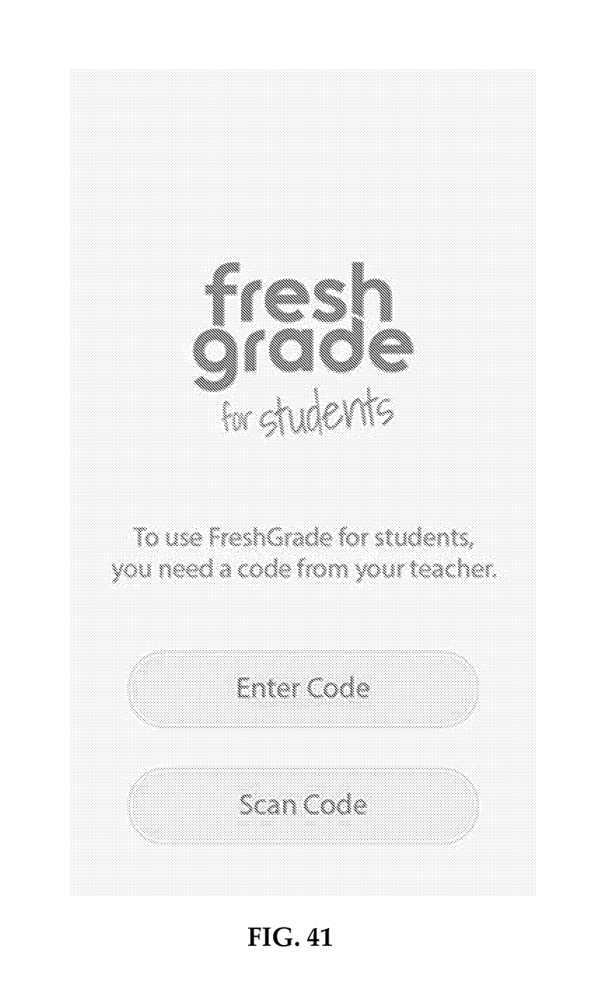

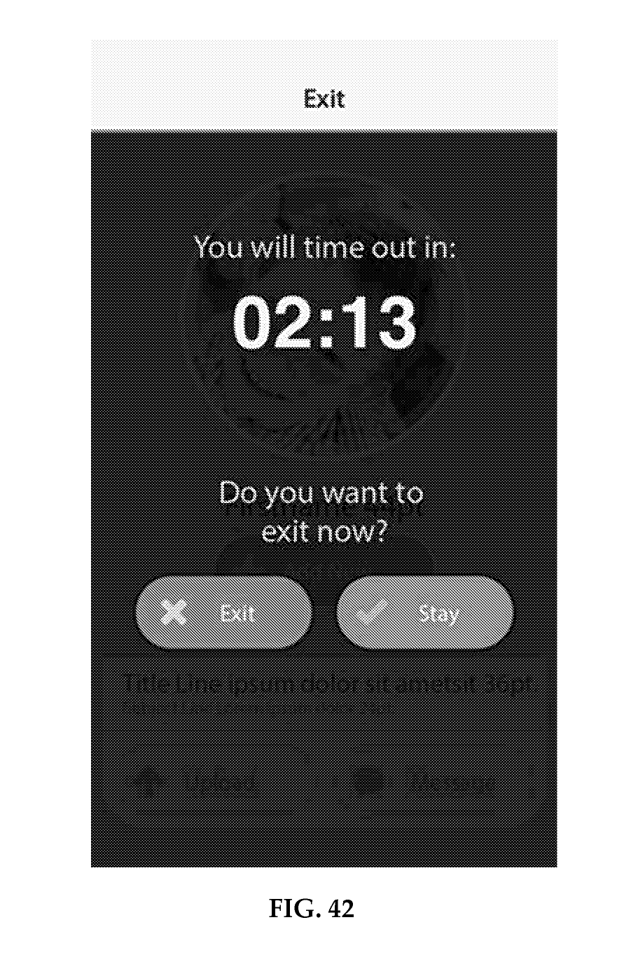

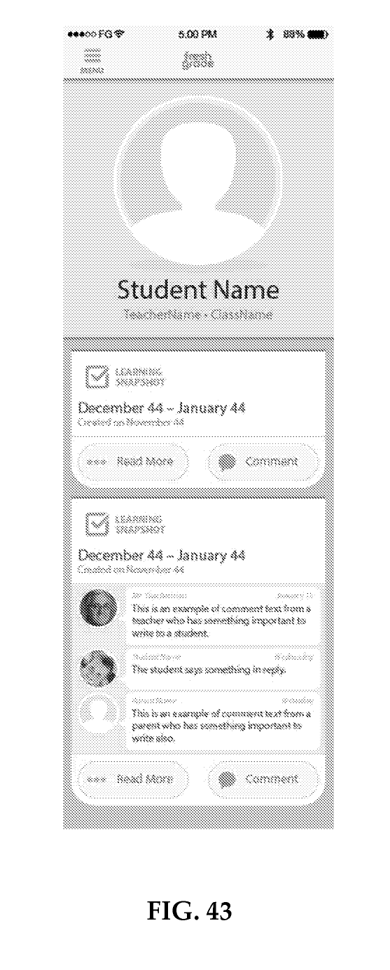

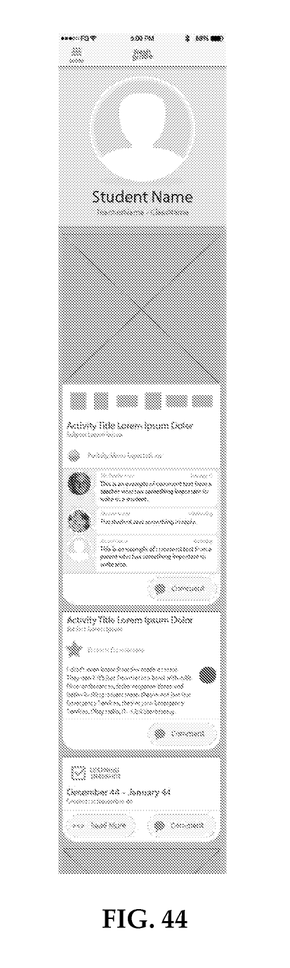

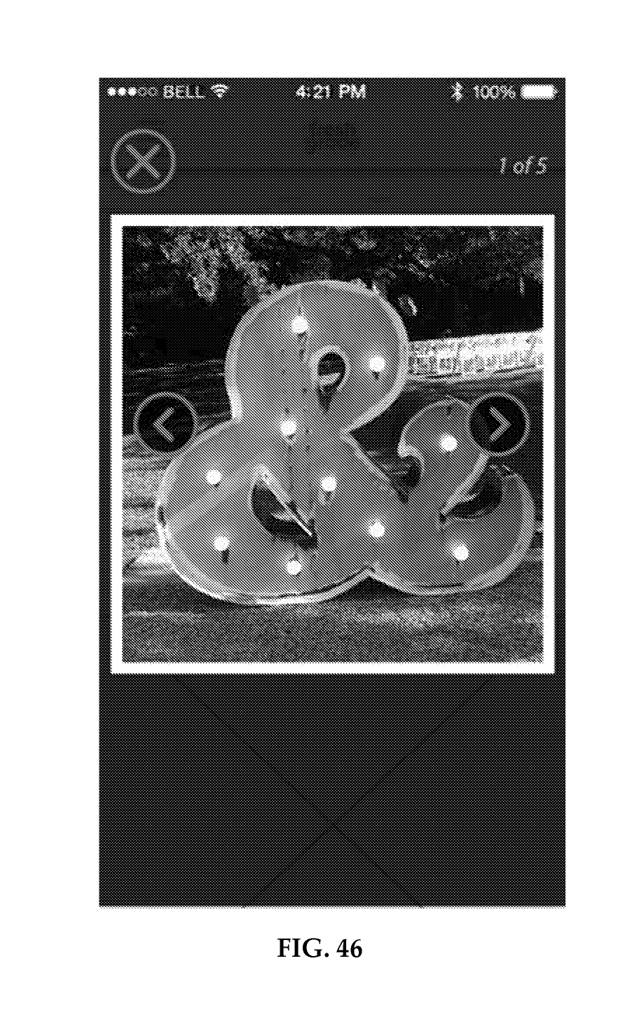

In more detail, the server 110 provides a plurality of graphical user interfaces (GUIs) that are displayed on the client device 105. In some embodiments, the GUIs allow teachers, parents, and other end users to interact with the server 110 to create an individualized learning experience for students. The various GUIs will be discussed in greater detail below relative to FIGS. 3A-46.

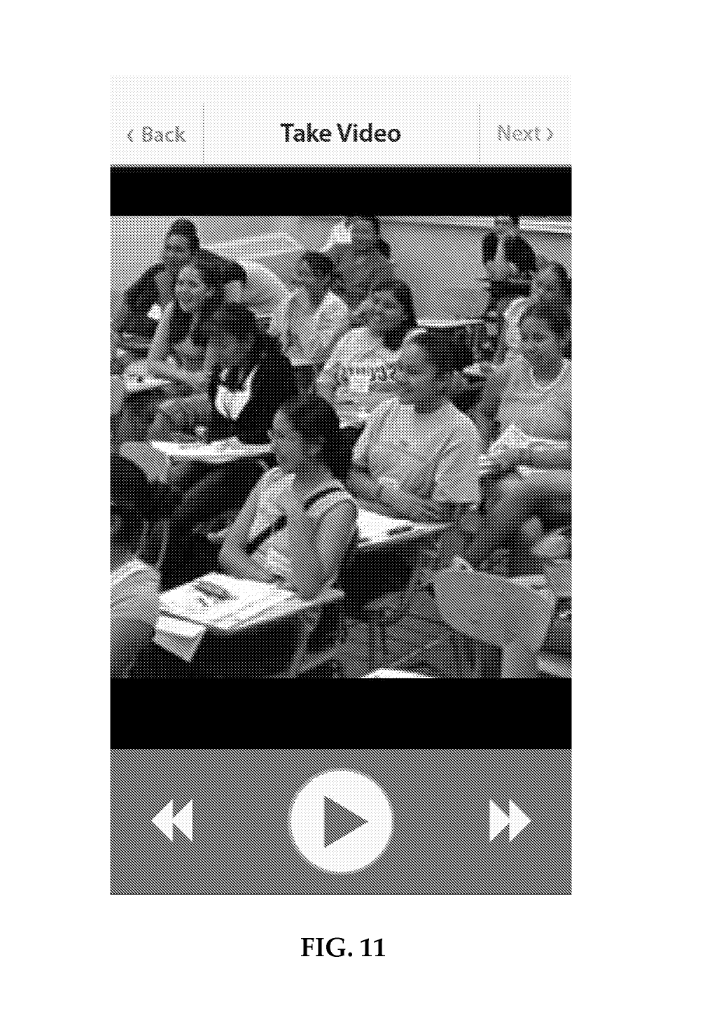

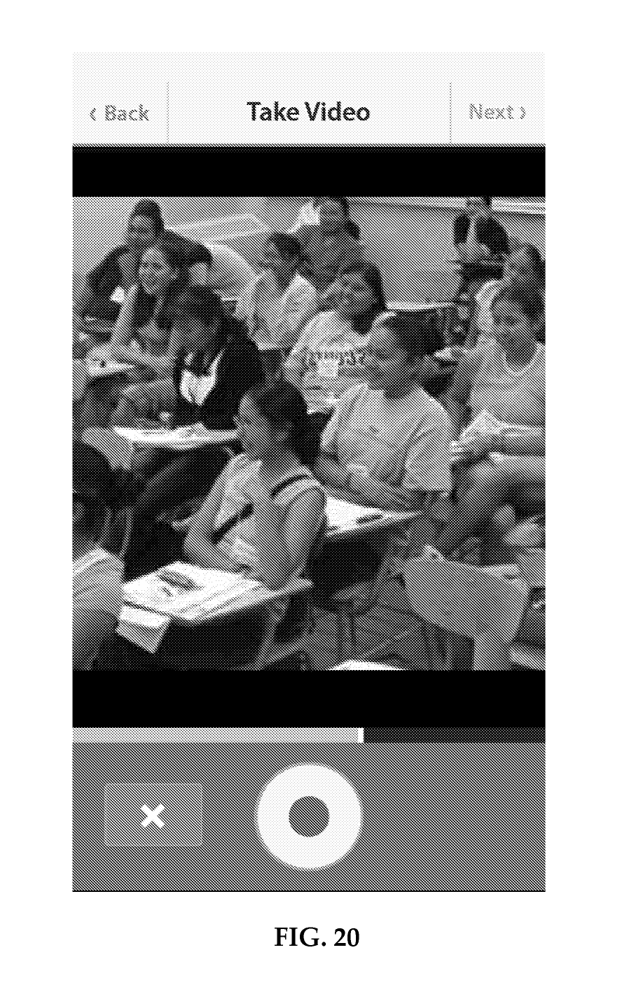

In some embodiments, the evidence capture module 120 allows a user to obtain numerous types of evidence of learning such as video, audio, images, text, and so forth. In one embodiment, the client device 105 actuates one or more integrated I/O devices such as microphones, cameras, and so forth in response to user requests. By way of example, the client device can display various interfaces that provide the user with mechanisms that activate these I/O devices. In one embodiment, a video capture UI 300, as illustrated in FIG. 3A is displayed. The UI 300 can include an actuator button 305 that allows the user to capture video displayed within a frame 310. To be sure, the frame 310 displays images obtained through a camera of the client device 105. In this example, a teacher is obtaining video evidence of learning by capturing an event in a classroom. FIGS. 11 and 20 also illustrate UIs that can be used to process video evidence of learning. For example, FIG. 11 allows a user to play a video evidence of learning. FIG. 20 allows a user to pause or re-capture portions of a video.

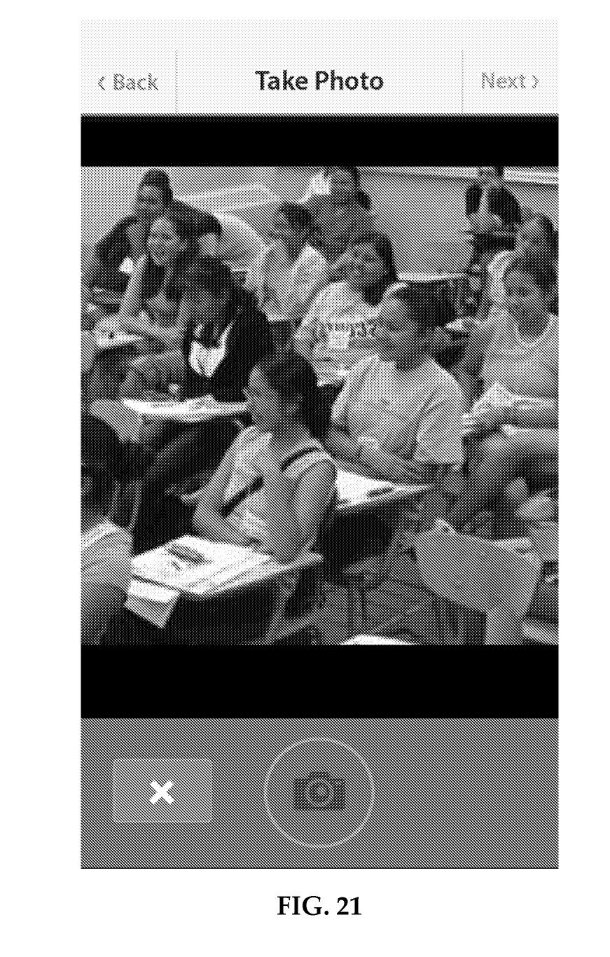

FIG. 3B illustrates another UI 315 that is similar to the UI of FIG. 3A with the exception that the UI 315 is configured to capture image evidence of learning. Other UIs that can be used to capture image evidence of learning include FIG. 21.

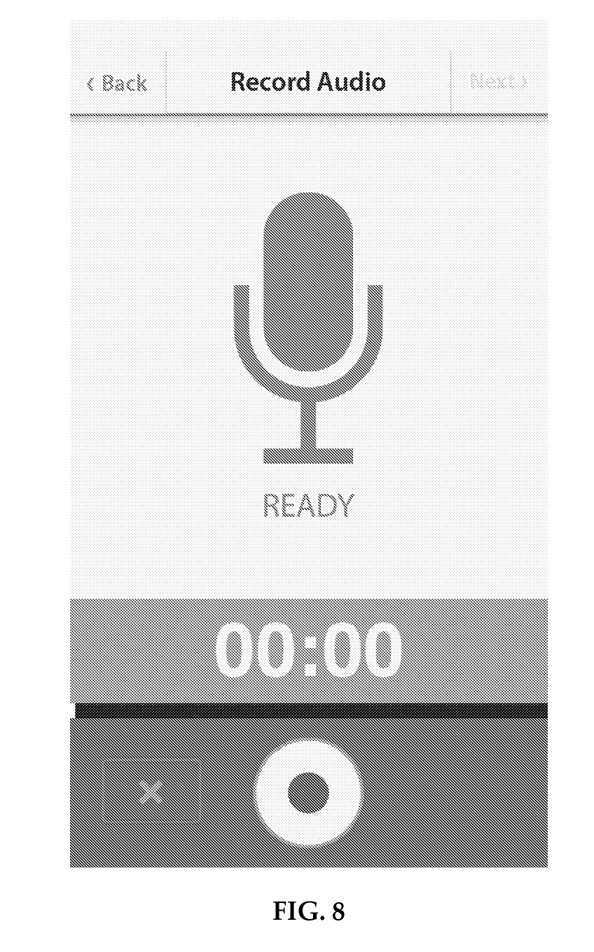

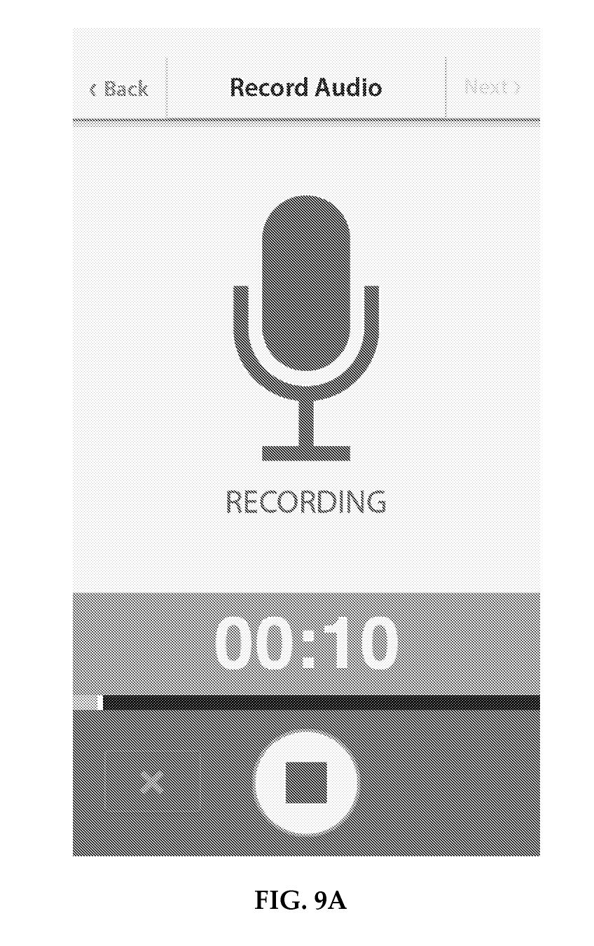

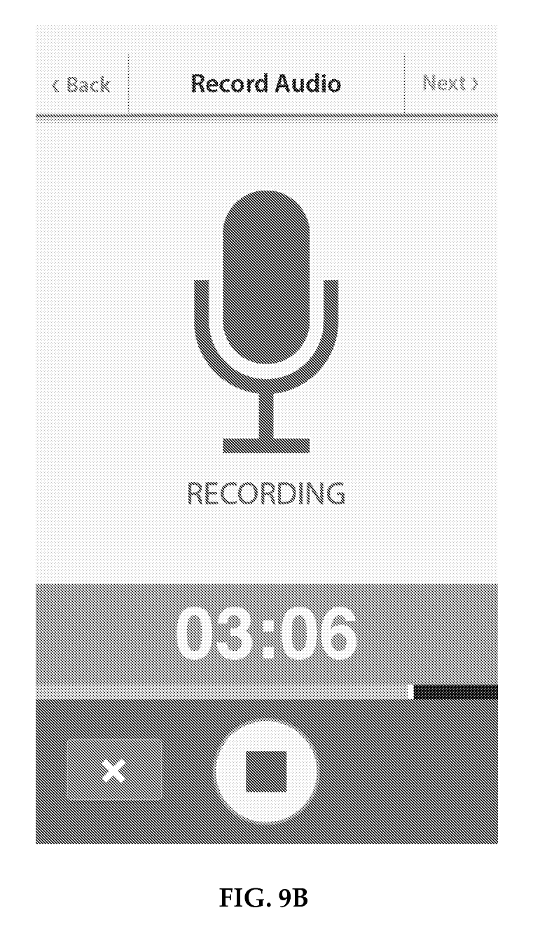

Other UIs for capturing evidence of learning include FIGS. 8-9B for recording audio evidence of learning.

Advantageously, the user can utilize the various UIs provided to obtain evidence of learning across a plurality media types. Thus, for a student or class, the teacher can obtain video, images, and audio evidence of learning that provide a robust and detailed account of a student or class' academic progress.

An additional aspect of evidence of learning includes the capturing of narrative content, which can be provided by a teacher or other educator. A teacher can use various UIs to input narrative content regarding a student or class. In one embodiment the narrative content can pertain to instances of evidence. For example, the teacher can write a quick note about a video taken of a class. The narrative content is used to supply context for the video or provide additional evidence of learning, such as a narrative about student or class performance.

As evidence is obtained, the server 110 can store the evidence in a storage medium, such as a data store. The server 110 can temporarily store captured evidence in general storage. The teacher or other user can cause the server 110 to store evidence in a student account or student profile, in some embodiments.

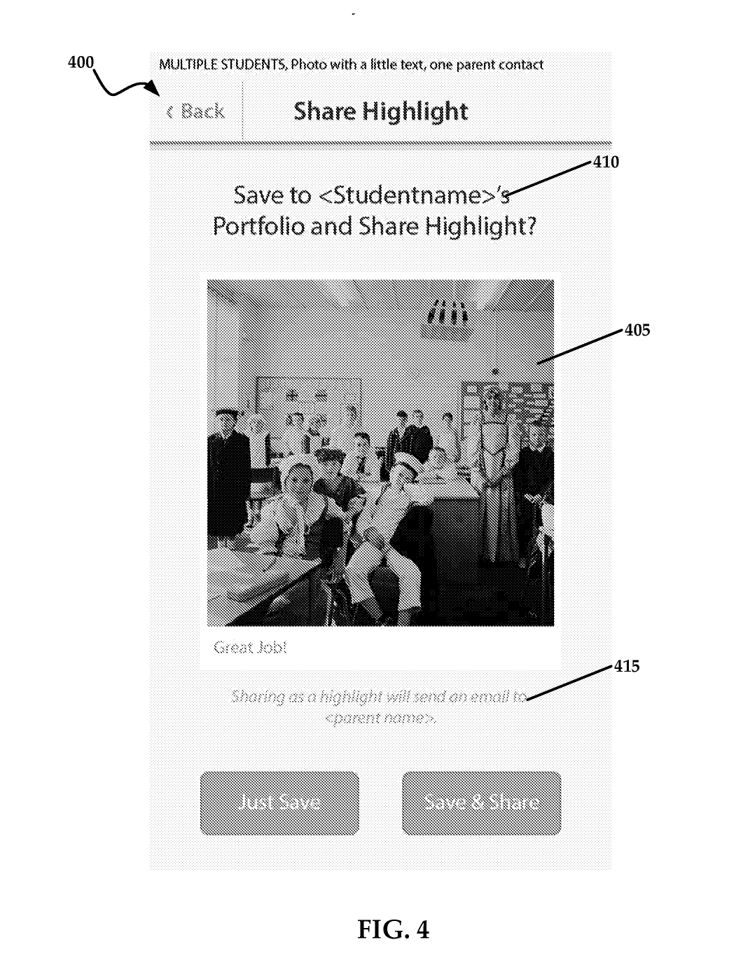

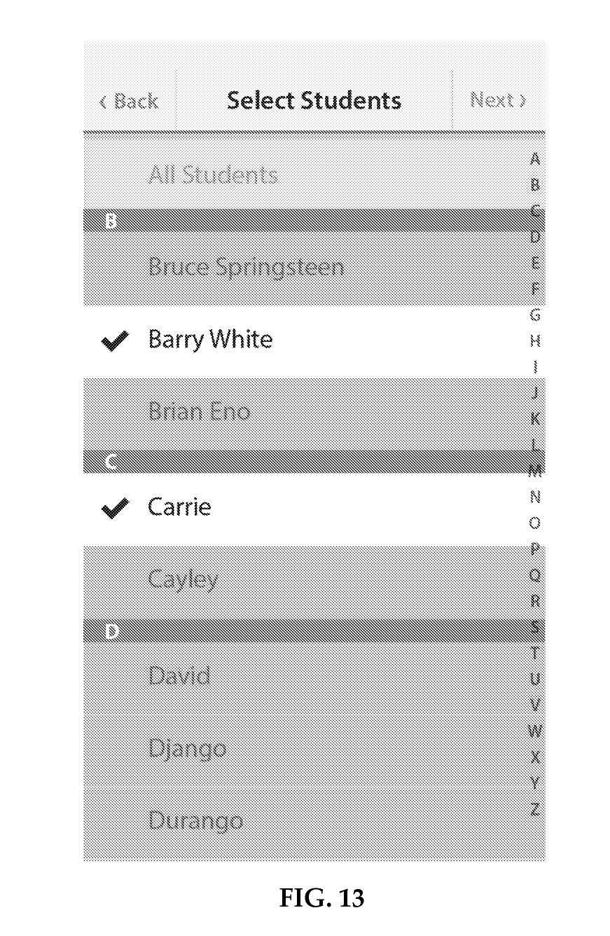

FIG. 4 illustrates a highlight UI 400 that can be used to store an image evidence of learning in a student profile, as well as share the evidence with a parent associated with the student profile. For example, image evidence 405 can be stored in a student profile by selection of a student identifier 410. The UI can include a text input box where the teacher can input a student name as an identifier. In another embodiment, the student name can be selected from a list, as illustrated in FIG. 13.

A parent can also receive the image evidence 405. A parent identifier can be selected by the teacher. The parent identifier 415 is displayed below the image evidence 405. The UI 400 can include a save button and a save and share button. If the save and share button is selected, the image evidence is stored in the student profile and the evidence is transmitted to the parent, for example via email.

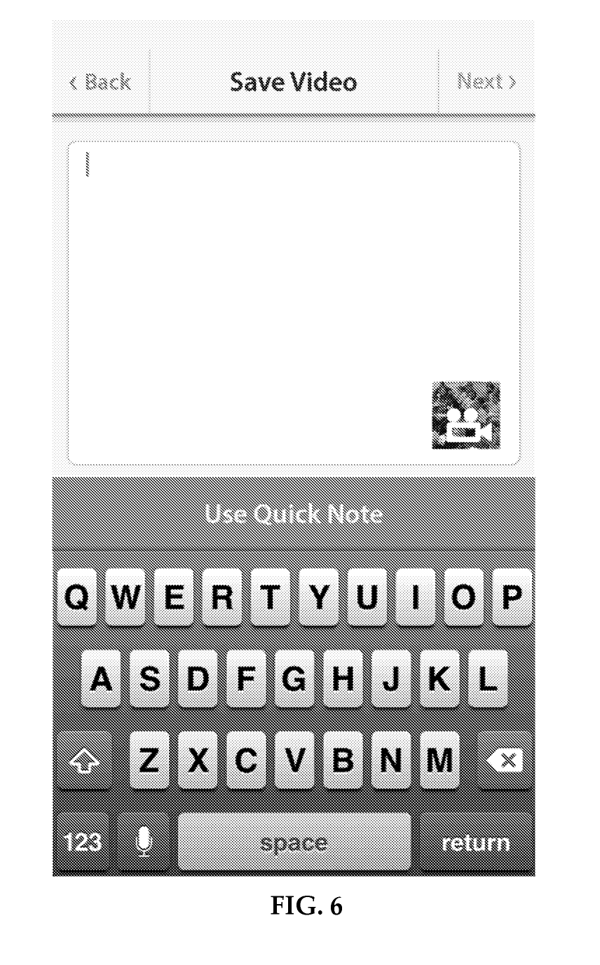

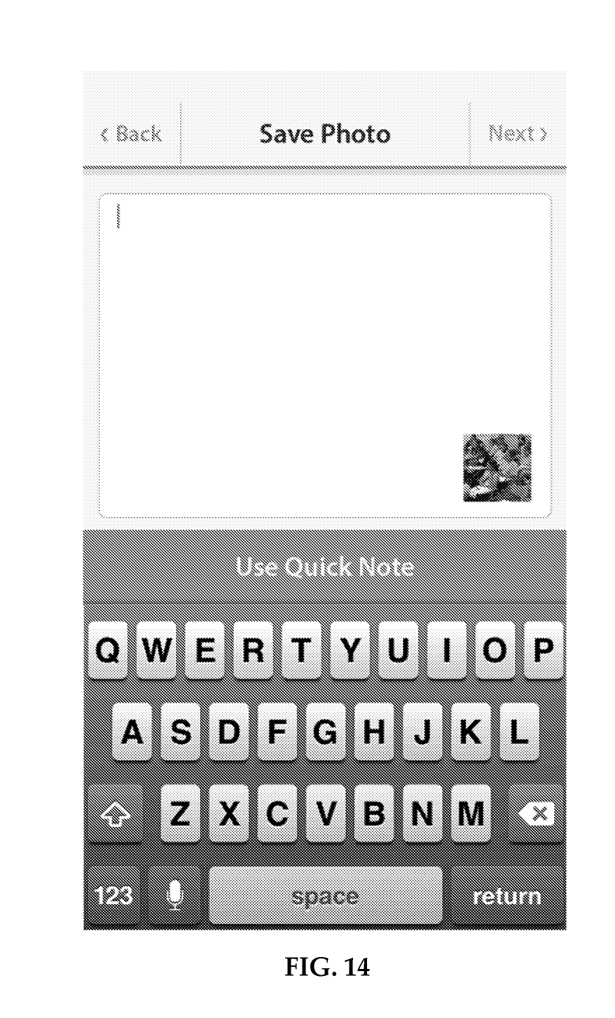

In FIG. 6, a teacher can include anecdotal evidence/narrative content by typing a note into a text box. In this example video evidence is selected for narration and displayed as a small image in a right lower corner of the text box. A similar UI is illustrated in FIG. 14 for narrating image evidence.

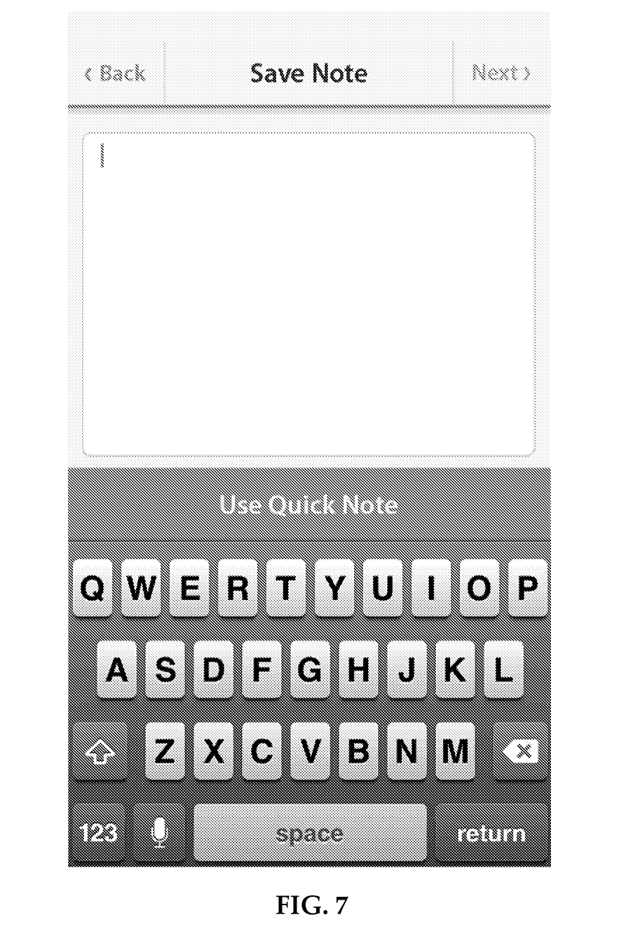

In FIG. 7 a teacher can create anecdotal evidence/narrative content that can be stored for a student. The anecdotal evidence/narrative content is not directly linked to any evidence of learning media.

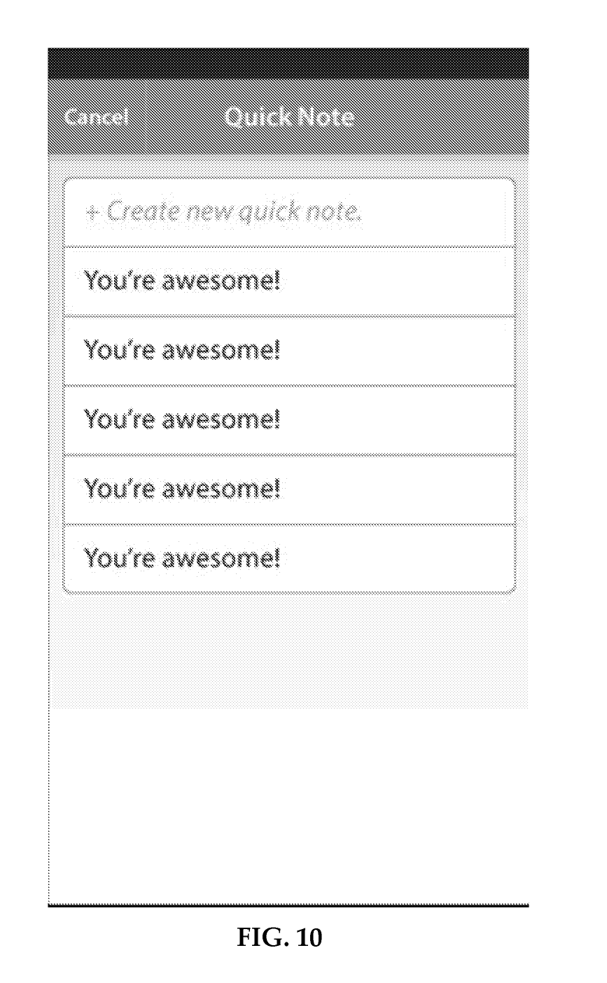

FIG. 10 illustrates a plurality of quick note options. Quick notes can be used to speed up an evidence narration process. For example, the teacher can create and use quick notes to annotate or narrate evidence of learning media types.

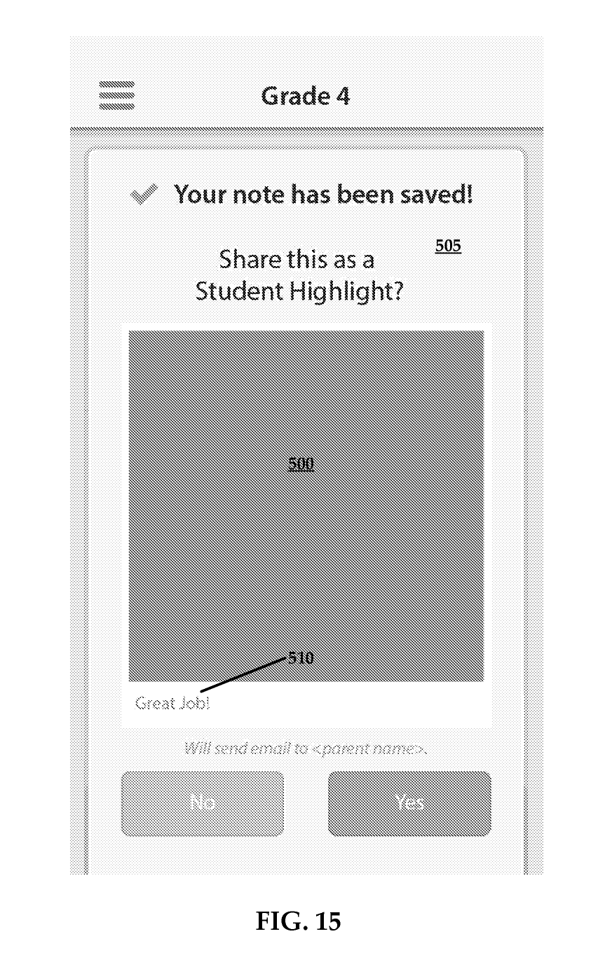

In some embodiments, evidence of learning 500 is obtained and is narrated by a teacher. After the evidence is narrated it can be stored as a note. FIG. 15 illustrates a UI that allows a teacher to create a highlight 505. A highlight can be a message that is representative of a positive learning experience, as captured as one or more types of evidence. A highlight can include the narration provided by a teacher as well. In some embodiments, the teacher can append a quick note 510 to the evidence of learning media. The highlight 505 can be shared with a parent or other individual through selection of a yes button.

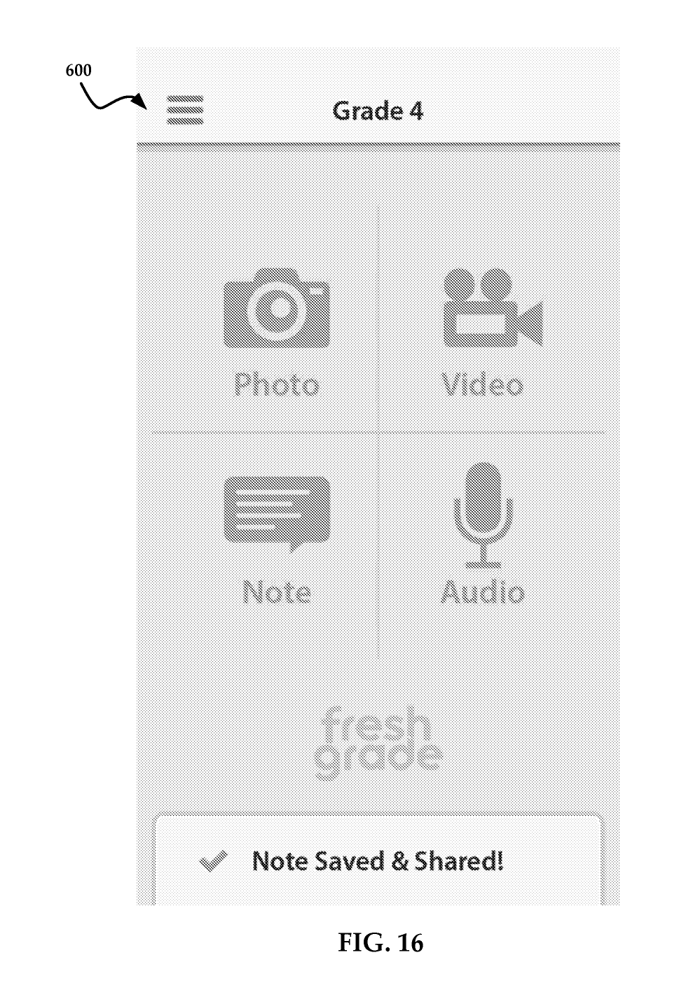

FIGS. 16-18 each illustrate a view of a dashboard 600 that allows a user to select a media type from a plurality of media types. The media types include a photo, a video, a note, and an audio. Selection of a media type will activate any required hardware and display corresponding UIs for capturing the selected evidence of learning media type. For example, if the teacher selects the video media sector of the dashboard 600, the client device will cause a camera to begin to obtain video evidence of learning.

As mentioned above, the anecdotal/narrative information obtained from a teacher can be captured using the evidence assessment module 125. That is, the evidence assessment module 125 provides the teacher with the ability to create notes, highlights, and other similar assessments of student performance that augment the evidence of learning obtained for a student. In some embodiments, notes can be created and then edited at a later point in time, if desired.

According to some embodiments, the server 110 can utilize the evidence assignment module 140 to assign captured evidence to a student account. This can also include the assessment information captured by the evidence assessment module 125.

For example, the server 110 can determine that certain evidence is indicative of one or more students. This can occur when a teacher selects the students as being associated with a particular type of evidence. For example, when a teacher obtains an image of a student engaged in a school project, the student can be tagged to the image. The server 110 then assigns that evidence to the tagged student and their student account.

In some embodiments, the evidence assessment module 125 can be used to assign evidence to a subject for the student. For example, if the evidence of learning is a video of an oral book report, the evidence assessment module 125 can assign the video to a subject of literature for the student. Evidence for a plurality of subject can be identified in a similar manner to create a categorization of evidence for the student that is based on subject matter such as mathematics, history, English, science, and so forth.

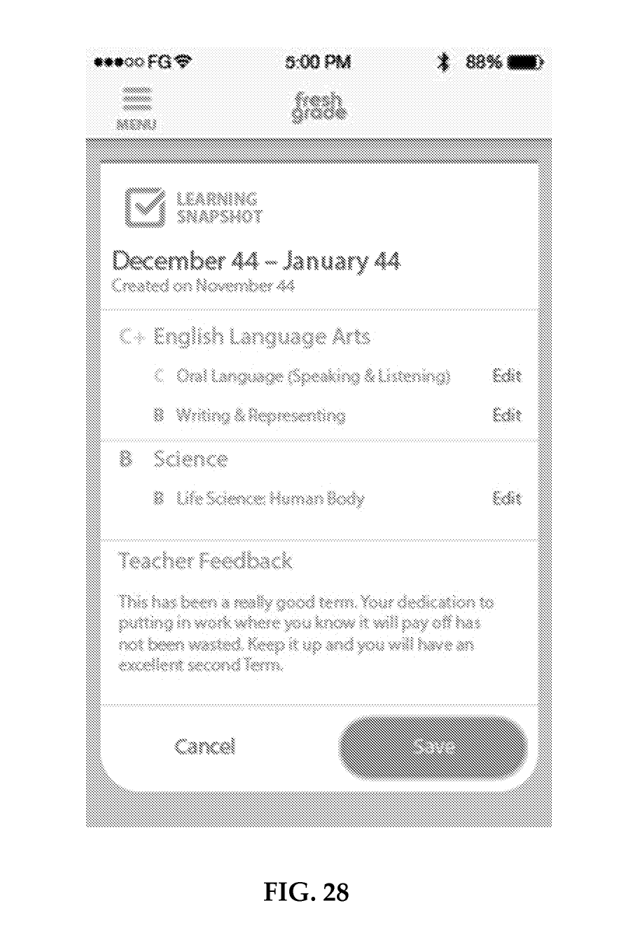

In some embodiments, the evidence assessment module 125 can be utilized to assess a student's performance in one or more subjects. The evidence assessment module 125 provides the teacher, in some embodiments, with a mechanism for evaluating a student's performance in one or more subjects. As illustrated in FIG. 28, the teacher can assign grades for the student in subjects such as English Language Arts and Science. The teacher can also provide feedback that can be obtained or summarized from the anecdotal/narrative content stored in the student account.

Once the evidence has been assigned to one or more students, the server 110 can receive any of the obtained and assigned media types from the client device and synchronize the obtained evidence with one or more student accounts using the evidence synchronization module 135. The synchronization of evidence can include, for example, simultaneous storage of the evidence across multiple student accounts. Synchronization can occur as evidence is obtained, such that the client device 105 can stream evidence back to the server 110 for storage. In other embodiments, the client device 105 can obtain evidence and store it locally. The client device 105 can asynchronously transmit the evidence to the server 110 in batches and/or at predetermined times. For example, the client device 105 can wait to transmit its stored evidence until the client device 105 is connected to a high capacity wireless network, such as WiFi.

In some embodiments, the server 110 can synchronize evidence with a student account because the teacher can select a student account(s) as an initial step in the evidence gathering process. Thus, any evidence obtained after selection of the student account(s) is automatically synched to the selected account(s).

According to some embodiments, the obtained evidence that is stored in a student account can be utilized by the server 110 to create or populate a student portfolio. The student portfolio is a virtual document that includes all the accumulated evidence of learning stored in a student account. The student portfolio provides the teacher and parents with a media augmented historical representation of the student's progress over a period of time.

As mentioned above, the server 110 can transmit various notifications, such as notes, highlights, portfolios, and other reports to parents. The server 110 can utilize the evidence transmission module 130 to provide transmission functionalities. The evidence transmission module 130 can maintain student and parent contact information, as well as linkages between parent contact information and student accounts/profiles.

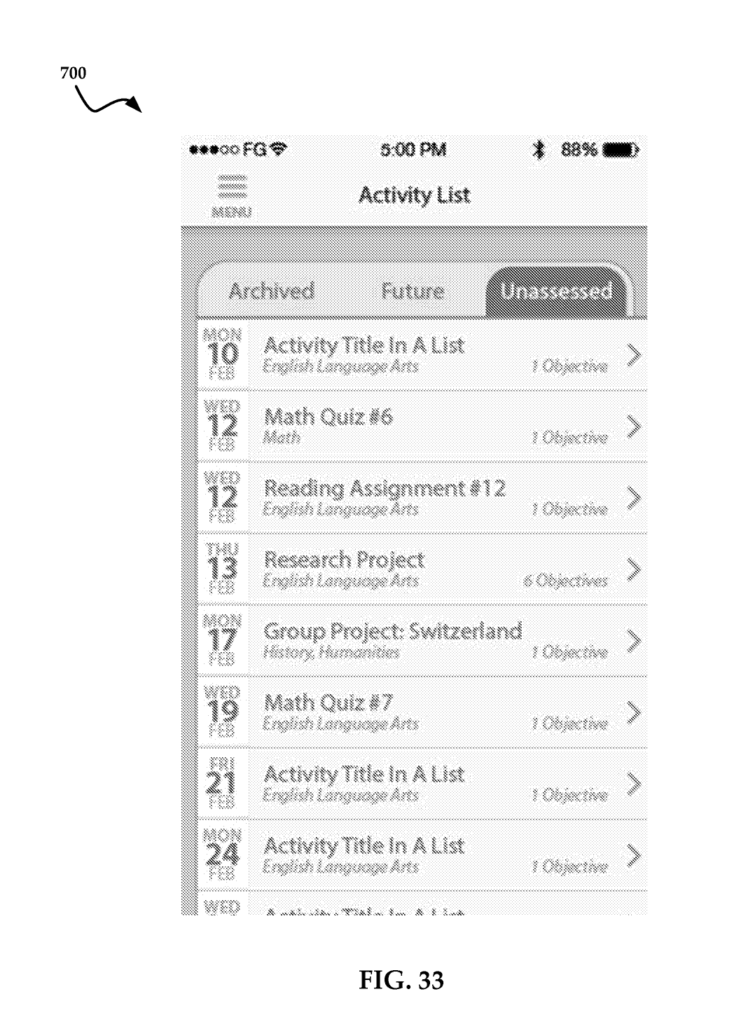

In some embodiments, the teacher can select an activity to associate with an evidence of learning. FIG. 33 illustrates an activity assessment list GUI 700 that includes a plurality of activities that require assessment by a teacher. The GUI 700 includes a list of activities that require an assessment. In one embodiment, the teacher can create an assessment of an activity, such as math quiz #6 which involves an interactive quiz that requires student participation in an exercise. The teacher can obtain evidence of learning, such as the student participating in the exercise. The teacher can assess a student's performance by obtaining the captured evidence and narrating the same. The evidence can be used by the teacher as a prompt to remember certain aspects of the exercise. For example, if a student did particularly well in a portion of the exercise, the teacher can take a picture of that portion of the exercise and notate the picture with information about the student's performance.

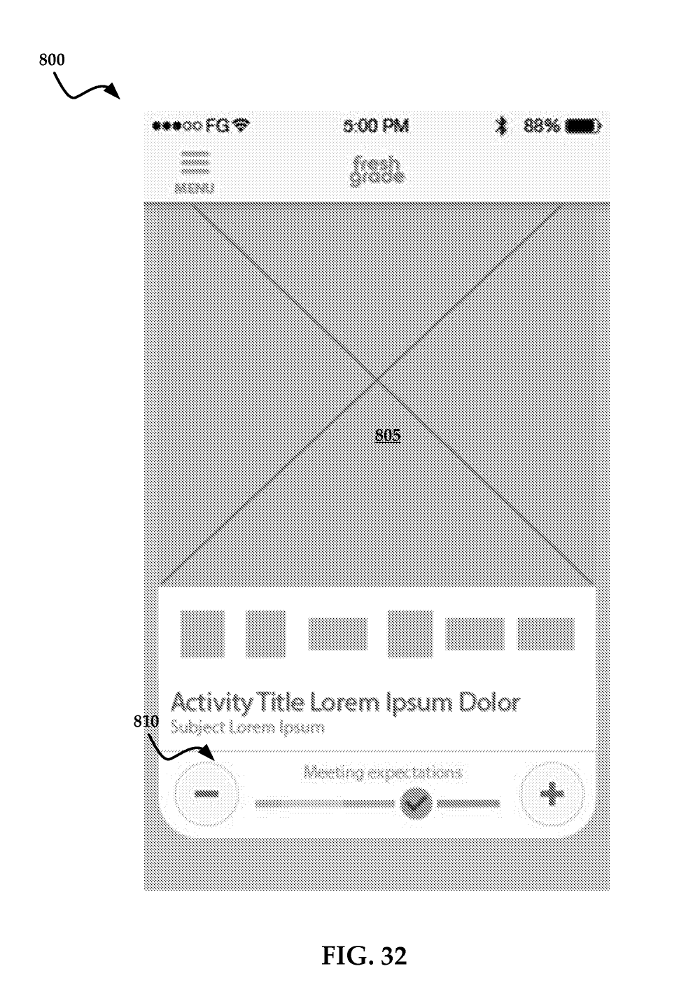

In some embodiments, the teacher can evaluate or assess an activity for a student using an assessment GUI, such as an activity summary GUI 800 of FIG. 32. The UI 800 can include various evidences of student learning displayed with a frame 805. The evidence of student learning is assessed for an activity by providing an activity summary GUI 800 selected from the activity assessment list GUI (see FIG. 33).

The activity assessment GUI 800 includes a slider 810 that can be selectively moved to change an assessment value for the activity.

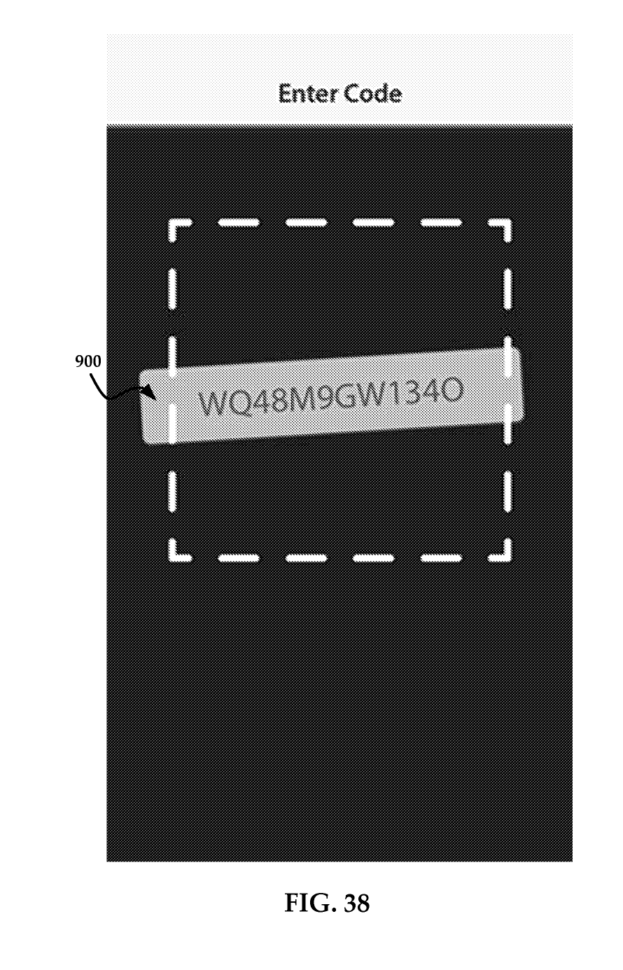

According to some embodiments, the server 110 can utilize a scannable/inputtable code that is linked to a student account/profile. FIG. 38 illustrates an example scanning process where a scannable code 900 is scanned by a client device. For example, a camera of the client device can obtain an image of the scannable code 900. The scannable code 900 is pre-linked to a student account, in some embodiments. When the scannable code is scanned, any evidence obtained is directly assigned and synched to the linked student account. To be sure, scannable code is unique to a student account. In other embodiments, the scannable code is linked to a class, which is in turn linked to a plurality of student accounts. When evidence is captured using the class scannable code the evidence is automatically assigned and synched with the student accounts that are linked to the class account. The server 110 is configured to store the evidence of student learning in the student account linked to the unique scannable code.

In some embodiments, the server 110 receives a signal indicative of a scanning of the unique scannable code prior to receiving evidence of student learning.

Various embodiments of aspects and features of the present technology are disclosed in FIG. 3A through FIG. 46. In some embodiments, aspects and features include capturing, assessing and communicating evidence of student learning. The capturing, communicating and assessing of student learning make it possible for teachers to provide an individualized learning experience for students.

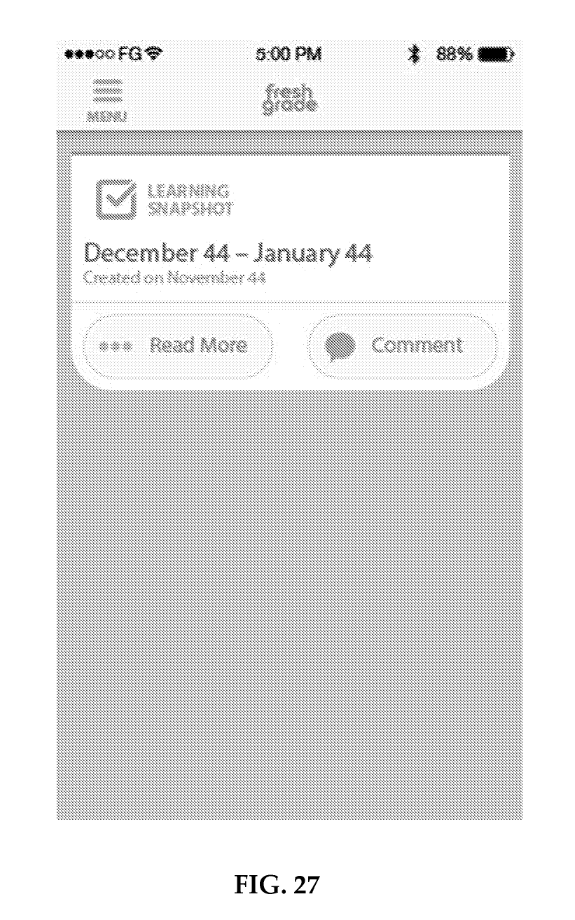

The software interfaces include but are not limited to the various embodiments shown in FIG. 3A through FIG. 26, including the following aspects of the present technology: take video, take photo, share highlight, save video, save note, record video, quick note, preview video, preview audio, select students, photo note, saved photo, saving and sharing photos, menu, note saved menu, login, confirm video, confirm photo, confirm audio, choose video, choose photo, audio note and application icon. The software interfaces further include but are not limited to the embodiments shown in FIG. 27 through FIG. 46, including the following aspects of the present technology: teacher snapshot, teacher comment, teacher assess, teacher activity, student portfolio mobile device, student portfolio comment, student portfolio comment with attachments, student mobile scan code, student mobile new entry, student mobile login, student mobile disconnect, parent portfolio snapshot, parent portfolio menu, and parent portfolio light box. The various embodiments of software interfaces may be displayed as components of GUIs.

In some instances, capturing evidence of student learning may include taking videos, photos and audio recordings, as well as anecdotal notes of these videos, photos and audio recordings. In other instances, capturing evidence of student learning may include uploading it to a student profile, and assigning it to one or more classes and/or subjects and/or activities in the student profile. In other embodiments, capturing student learning includes adding and editing the anecdotal notes. The present technology may also include assigning evidence of student learning to one or more student profiles. In various embodiments, the evidence of student learning may be synced to one account when connected to a network.

Turning back to FIG. 2, FIG. 2 illustrates an exemplary computing device 200 that may be used to implement an embodiment of the present systems and methods. The system 200 of FIG. 2 may be implemented in the contexts of the likes of computing devices, networks, servers, or combinations thereof. The computing device 200 of FIG. 2 includes one or more processors 210 and main memory 220. Main memory 220 stores, in part, instructions and data for execution by processor 210. Main memory 220 may store the executable code when in operation. The system 200 of FIG. 2 further includes a mass storage device 230, portable storage device 240, output devices 850, user input devices 260, a display system 270, and peripheral devices 280.

The components shown in FIG. 2 are depicted as being connected via a single bus 290. The components may be connected through one or more data transport means. Processor unit 210 and main memory 220 may be connected via a local microprocessor bus, and the mass storage device 230, peripheral device(s) 280, portable storage device 240, and display system 270 may be connected via one or more input/output (I/O) buses.

Mass storage device 230, which may be implemented with a magnetic disk drive or an optical disk drive, is a non-volatile storage device for storing data and instructions for use by processor unit 210. Mass storage device 230 may store the system software for implementing embodiments of the present technology for purposes of loading that software into main memory 220.

Portable storage device 240 operates in conjunction with a portable non-volatile storage medium, such as a floppy disk, compact disk, digital video disc, or USB storage device, to input and output data and code to and from the computer system 200 of FIG. 2. The system software for implementing embodiments of the present technology may be stored on such a portable medium and input to the computer system 200 via the portable storage device 240.

User input devices 260 provide a portion of a user interface. User input devices 260 may include an alphanumeric keypad, such as a keyboard, for inputting alpha-numeric and other information, or a pointing device, such as a mouse, a trackball, stylus, or cursor direction keys. Additional user input devices 260 may comprise, but are not limited to, devices such as speech recognition systems, facial recognition systems, motion-based input systems, gesture-based systems, and so forth. For example, user input devices 260 may include a touchscreen. Additionally, the system 200 as shown in FIG. 2 includes output devices 250. Suitable output devices include speakers, printers, network interfaces, and monitors.

Display system 270 may include a liquid crystal display (LCD) or other suitable display device. Display system 270 receives textual and graphical information, and processes the information for output to the display device.

Peripherals device(s) 280 may include any type of computer support device to add additional functionality to the computer system. Peripheral device(s) 280 may include a modem or a router.

The components provided in the computer system 200 of FIG. 2 are those typically found in computer systems that may be suitable for use with embodiments of the present technology and are intended to represent a broad category of such computer components that are well known in the art. Thus, the computer system 200 of FIG. 2 may be a personal computer, hand held computing device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows, Mac OS, Palm OS, Android, iOS (known as iPhone OS before June 2010), QNX, and other suitable operating systems.

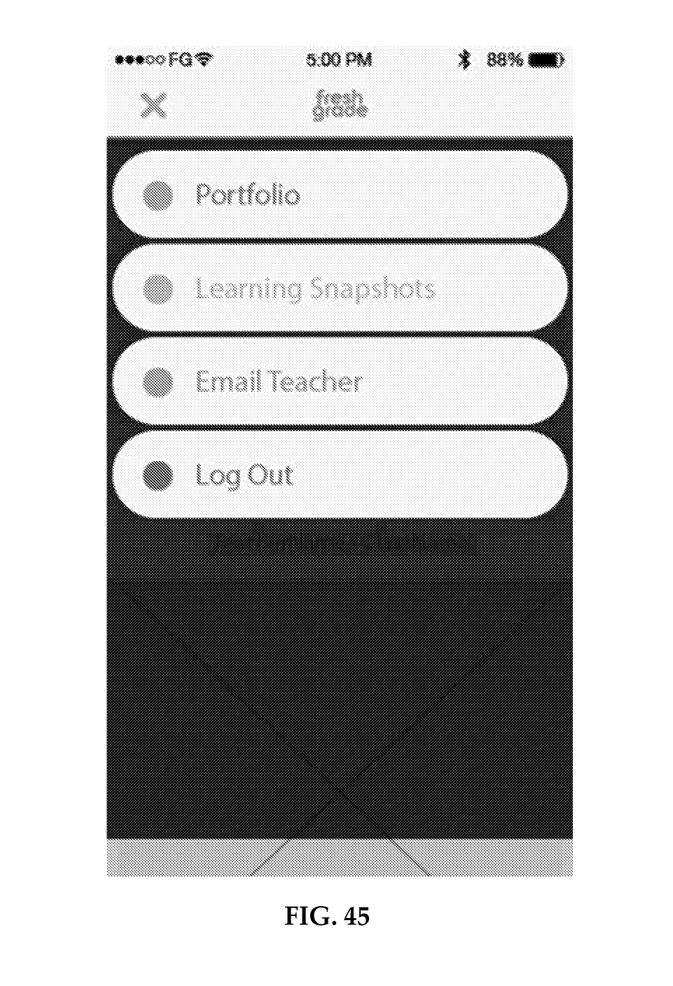

FIG. 45 is a flowchart of an example method for capturing and utilizing evidence of learning for a student. In some embodiments, the method includes a server providing 1005 a plurality of graphical user interfaces (GUIs). The plurality of graphical user interfaces are utilized for capturing unique categories of evidence of student learning. Examples of unique categories include, but are not limited to, video, audio, image, textual (e.g., narrative/anecdotal) and so forth. To be sure, the evidence of student learning can advantageously span a plurality of media types.

Next, the method includes the server receiving 1010 evidence of student learning comprising both media content of student activities and narrative content from a teacher using the plurality of graphical user interfaces. Thus, the media and narrative content are received through the plurality of GUIs provided in step 1005.

In some embodiments, the method includes the server synchronizing 1015 the evidence of student learning with one or more student accounts. As mentioned above, the evidence can be synchronized with a student's account/profile by selection of a student account. In another example, the user can select a class and the evidence can be synched across the class. The student accounts can be linked to a class. When the class is selected, the server can synch the evidence to each student linked to the class. In some embodiments, the method comprises the server assigning 1020 at least a portion of the evidence of student learning to a student portfolio. Advantageously, the student portfolio includes the wide variety of media evidence and narrative/anecdotal evidence of student learning. A student portfolio which includes this wide variety of evidence of student learning contributes to a more individualized learning plan for student. The student portfolio also allows parents, teachers, and administrators to easily determine student progress, not merely by viewing grades and teacher evaluation, but by watching or listening the student performing educational activities. These media types can be advantageous in assisting educators in determining students who are underperforming of may have learning disabilities. Likewise, the media evidence of learning included in a portfolio can also be utilized to determine positive student performance in various educational activities.

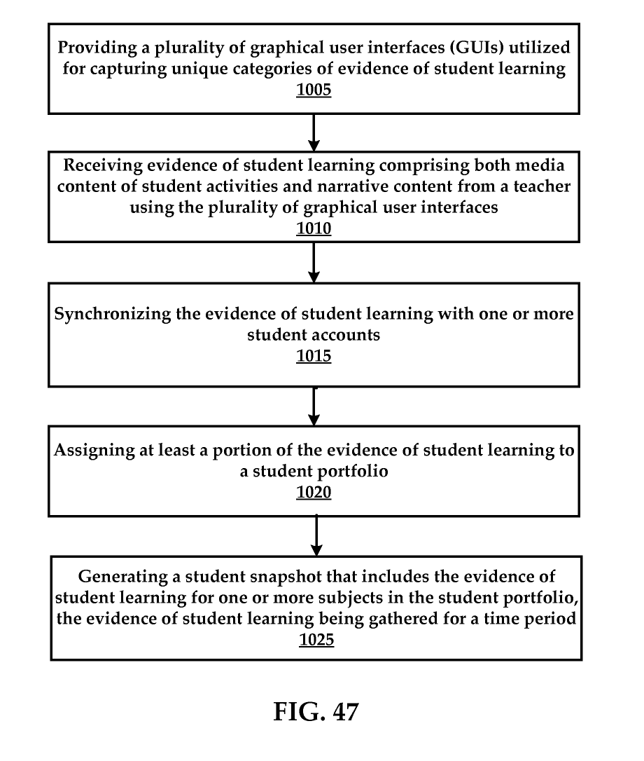

In some embodiments, the method can include an option step of generating 1025 a student snapshot that includes the evidence of student learning for one or more subjects in the student portfolio. In some embodiments, the evidence of student learning being gathered for a time period. The snapshot can be shared with parents or other end users. It will also be understood that additional or fewer steps can be utilized in the method of FIG. 47.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be coupled with the user's computer through any type of network, including a LAN or a WAN, or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A machine-implemented method, comprising:
capturing, by a server, evidence of student learning;
assessing, by a server, the evidence of student learning; and
communicating, by a server, the evidence of student learning,
in which the capturing, the communicating, and the assessing make it possible for teachers to provide an individualized learning experience for students.

2. The machine-implemented method of claim 1, further comprising:
syncing, by a server, the evidence of student learning to one account when connected to a network.

3. The machine-implemented method of claim 1, in which the capturing, by a server, further comprises taking at least one of a video, a photo, an audio recording, or an anecdotal note of the evidence of student learning.

4. The machine-implemented method of claim 1, further comprising:
assigning, by a server, the evidence of student learning to a student profile.

5. The machine-implemented method of claim 1, in which the capturing, by a server, further comprises:
uploading, by a data processing device, the evidence of student learning to a student profile; and
assigning, by a data processing device, the evidence of student learning to a subject in the student profile.

6. The machine-implemented method of claim 1, in which the capturing, by a server, further comprises adding an anecdotal note to the evidence of student learning and editing the anecdotal note.

7. A non-transitory medium, readable through one or more processors and including instructions embodied therein that are executable through the one or more processors, comprising:
instructions to capture, at an interface of a data processing device, evidence of student learning;
instructions to assess, at an interface of a data processing device, the evidence of student learning; and
instructions to communicate, at an interface of a data processing device, the evidence of student learning,
in which the instructions to capture, communicate, and assess make it possible for teachers to provide an individualized learning experience for students.

8. The non-transitory medium of claim 7, further comprising:
instructions to sync, at an interface of a data processing device, the evidence of student learning to one account when connected to a network.

9. The non-transitory medium of claim 7, wherein instructions to capture, at an interface of a data processing device, further comprises:
instructions to take a video, at an interface of a data processing device, of the evidence of student learning;
instructions to take a photo, at an interface of a data processing device, of the evidence of student learning; and
instructions to take an audio recording, at an interface of a data processing device, of the evidence of student learning.

10. The non-transitory medium of claim 7, further comprising:
instructions to assign, at an interface of a data processing device, the evidence of student learning to a student profile.

11. The non-transitory medium of claim 7, wherein instructions to capture, at an interface of a data processing device, further comprises:
instructions to upload, at an interface of a data processing device, the evidence of student learning to a student profile; and
instructions to assign, at an interface of a data processing device, the evidence of student learning to a subject in the student profile.

12. The non-transitory medium of claim 7, wherein instructions to capture, at an interface of a data processing device, further comprises:
instructions to add an anecdotal note, at an interface of a data processing device, to the evidence of student learning; and
instructions to edit, at an interface of a data processing device, the anecdotal note.

13. A client device and server system comprising:
a memory;
one or more processors communicatively coupled to the memory;
one or more programs, stored in the memory and executed by the one or more processors;
an evidence capture module coupled to at least one of the one or more processors and instructed by at least one of the one or more programs to capture evidence of student learning;
an evidence assessment module coupled to at least one of the one or more processors and instructed by at least one of the one or more programs to assess the evidence of student learning; and
an evidence transmission module coupled to at least one of the one or more processors and instructed by at least one of the one or more programs to communicate the evidence of student learning.

14. The client device and server system of claim 13, further comprising an evidence synchronization module configured to sync the evidence of student learning to one account when connected to a network.

15. The client device and server system of claim 13, in which the evidence capture module to capture evidence of student learning is further configured to take at least one of a video, a photo, an audio recording, or an anecdotal note of the evidence of student learning.

16. The client device and server system of claim 13, further comprising an evidence assignment module configured to assign the evidence of student learning to a student profile.

17. The client device and server system of claim 13, further configured to:
upload the evidence of student learning to a student profile; and
assign the evidence of student learning to a subject in the student profile.

18. The client device and server system of claim 13, further configured to:
add an anecdotal note to the evidence of student learning; and
edit the anecdotal note.

19. A method, comprising:
providing a plurality of graphical user interfaces (GUIs), the plurality of graphical user interfaces for capturing unique categories of evidence of student learning, the evidence of student learning comprising a plurality of media types;
receiving evidence of student learning comprising both media content of student activities and narrative content from a teacher using the plurality of graphical user interfaces;
synchronizing the evidence of student learning with one or more student accounts; and
assigning at least a portion of the evidence of student learning to a student portfolio.

20. The method according to claim 19, wherein the evidence of learning comprises at least one of a video, a photo, an audio recording, and an anecdotal note of the evidence of student learning.

21. The method according to claim 19, wherein assigning at least a portion of the evidence of student learning to a student portfolio includes assigning portions of the evidence of student learning to a plurality of subjects.

22. The method according to claim 19, further comprising adding an anecdotal note to the evidence of student learning and editing the anecdotal note.

23. The method according to claim 19, further comprising generating the plurality of graphical user interfaces, the plurality of graphical user interfaces comprising a video capturing GUI and an image capturing GUI.

24. The method according to claim 19, further comprising generating the plurality of graphical user interfaces, the plurality of graphical user interfaces comprising a highlight sharing GUI that allows a teacher to:
store the evidence of student learning in a student account of the one or more student accounts; and
transmit the evidence of student learning to a parent associated with the student account.

25. The method according to claim 19, further comprising generating an activity assessment list GUI that includes a plurality of activities that require assessment by a teacher.

26. The method according to claim 19, wherein the evidence of student learning is a assessed for an activity by providing an activity summary GUI selected from the activity assessment list GUI, the activity assessment GUI includes a slider that can be selectively moved to change an assessment value for the activity.

27. The method according to claim 19, further comprising linking the student account with a unique scannable code.

28. The method according to claim 27, further comprising receiving a signal indicative of a scanning of the unique scannable code prior to receiving evidence of student learning.

29. The method according to claim 27, further comprising storing the evidence of student learning in the student account linked to the unique scannable code.

30. A method, comprising:
providing a plurality of graphical user interfaces (GUIs), the plurality of graphical user interfaces for capturing unique categories of evidence of student learning, the evidence of student learning comprising a plurality of media types;
receiving evidence of student learning comprising both media content of student activities and narrative content from a teacher using the plurality of graphical user interfaces;
synchronizing the evidence of student learning with one or more student accounts;
assigning at least a portion of the evidence of student learning to a student portfolio; and
generating a student snapshot that includes the evidence of student learning for one or more subjects in the student portfolio, the evidence of student learning being gathered for a time period.

31. A system, comprising:
a device, comprising:
a processor;
a memory for storing executable instructions, wherein the processor executes the instructions to:
cause a camera of the device to capture image or video evidence of student learning;
cause a microphone of the device to capture audio evidence of student learning;
cause a display of the device to present a graphical user interface that receives written evidence of student learning from a teacher; and
transmit the image or video evidence of student learning, audio evidence of student learning, and written evidence of student learning from a teacher to an assessment server; and
the assessment server, comprising:
an interface that receives the image or video evidence of student learning, audio evidence of student learning, and written evidence of student learning from the teacher;
a processor; and
a memory for storing executable instructions, wherein the processor executes the instructions to:
synchronize the evidence of student learning with one or more student accounts; and
assign at least a portion of the evidence of student learning to a student portfolio to create an individual learning experience.

32. The system according to claim 31, wherein the evidence of learning comprises at least one of a video, a photo, an audio recording, or an anecdotal note of the evidence of student learning.

33. The system according to claim 31, wherein the assignment of at least a portion of the evidence of student learning to a student portfolio includes assigning portions of the evidence of student learning to a plurality of subjects.

34. The system according to claim 31, wherein the device is configured to add an anecdotal note to the evidence of student learning in such a way that the anecdotal note can be edited.

35. The system according to claim 31, wherein the processor of the device causes a display of the device to present a graphical user interface that comprises a highlight sharing GUI that allows a teacher to:
store the evidence of student learning in a student account of the one or more student accounts; and
transmit the evidence of student learning to a parent associated with the student account.

36. The system according to claim 31, wherein the processor of the device causes a display of the device to present a graphical user interface that comprises an activity assessment list GUI that includes a plurality of activities that require assessment by a teacher.

37. The system according to claim 31, wherein the evidence of student learning is a captured for an activity by the processor of the device providing an activity summary GUI selected from the activity assessment list GUI, the activity assessment GUI includes a slider that can be selectively moved to change an assessment value for the activity.

38. The system according to claim 31, wherein the assessment server is further configured to link the student account with a unique scannable code, wherein the device is further configured to scan the unique scannable code prior to receiving evidence of student learning, wherein the assessment server is further configured to store the evidence of student learning in the student account linked to the unique scannable code.
